(19) United States
(12) Patent Application Publication
(10) Pub. No.: US 2012/0285336 A1
(43) Pub. Date: Nov. 15, 2012

(54) AUTOMATIC BREAD MAKER

(76) Inventors: Yasuyuki Ito, Tottori-shi (JP); Toshinari Kobayashi, Tottori-shi (JP); Yasushi Sone, Tottori-shi (JP); Syuji Fukuda, Tottori-shi (JP); Yoshinari Shirai, Tottori-shi (JP)

(21) Appl. No.: 13/574,139

(22) PCT Filed: Jan. 31, 2011
(86) PCT No.: PCT/JP2011/051873

§ 371 Date: Jul. 19, 2012

(30) Foreign Application Priority Data
Feb. 9, 2010 (JP) 2010-026517
Mar. 30, 2010 (JP) 2010-077200

(51) Int. Cl. A47J 37/01

(52) U.S. Cl. 99/348

(57) ABSTRACT

An automatic bread maker (1) comprises a body (10) in which a bread container (50) is accommodated; a grinding mechanism (54, 64) for grinding cereal grains in the container (50) accommodated in the body (10); a kneading mechanism (72, 60) for kneading into dough the bread ingredients in the bread container (50) accommodated in the body (10); and a bread ingredients storage container (80) for storing powdered bread ingredients to be automatically fed to the bread container (50) after the cereal grains have been ground by the grinding mechanism (54, 64).

### TECHNICAL FIELD

The present invention relates to an automatic bread maker used mainly in typical households.

### BACKGROUND ART

Automatic bread makers for home use on the market generally have a system to make bread in which a bread container, into which the bread ingredients are put, is used as the baking pan (e.g., refer to Patent Document 1). In such an automatic bread maker, a bread container into which bread ingredients have been put is first accommodated in a baking chamber in the body. The bread ingredients in the bread container are subsequently kneaded into a dough using a kneading blade provided in the bread container (kneading step). A fermentation step is then performed to ferment the kneaded dough, and the bread is baked using the bread container as the baking pan (baking step).

Among such automatic bread makers, there are those provided with an additional-ingredients container that can bake bread with raisins, nuts, cheese, and/or other additional ingredients (e.g., refer to Patent Documents 1 to 3). Such automatic bread makers are configured so that the additional ingredients put into the additional-ingredients container during the kneading step are automatically fed into the bread container by, e.g., program control.

### LIST OF CITATIONS

### Patent Documents

[Patent Document 1] Japanese Patent Publication No. 3191645
[Patent Document 2] Japanese Laid-open Patent Application No. 2006-255071
[Patent Document 3] Japanese Laid-open Patent Application No. 2008-279034

### SUMMARY OF INVENTION

### Technical Problem

Conventionally, flour (wheat flour, rice flour, and the like) produced by milling cereals such as wheat and rice, or mixed flour produced by mixing various supplementary ingredients into the milled flour, are required when bread is made using an automatic bread maker. In typical households, however, cereals are sometimes stored in a granular form instead of a powder, as with rice grains. Therefore, it would be extremely convenient if it were possible to make bread directly from cereal grains using an automatic bread maker. Accordingly, after diligent study the present applicants have invented a method for making bread using cereal grains as a starting ingredient. The present applicants have already submitted a patent application (Japanese Published Unexamined Application No. 2008-201507).

Here, the bread-making method for which an application has already been submitted is introduced. In this bread-making method, cereal grains are first mixed with a liquid, and the mixture is ground by a grinding blade (grinding step). Then, for example, gluten, yeast and other ingredients are fed into the paste-form ground flour obtained from the grinding step, and these bread ingredients are kneaded into a dough (kneading step). After the dough is fermented (fermentation step), the fermented dough is baked into bread (baking step).

In automatic bread makers that incorporate the above-described bread-making steps, powdered bread ingredients exemplified by gluten and dry yeast must be fed into the bread container after the cereal grains have been ground in the grinding step. Accordingly, it is possible to consider adopting an automatic bread maker configuration in which the user is notified using, e.g., a buzzer sound or the like about the timing for feeding the gluten or other powdered bread ingredients, and the user then feeds the gluten or other powdered bread ingredients. However, an automatic bread maker having such a configuration is extremely inconvenient in that the user must remain near the apparatus until the feed timing is reached.

The following problems were found in the case that the bread-making steps described above were applied in an automatic bread maker. As described above, water vapor is readily generated because the grinding step is performed in a state in which the cereal grains and a liquid have been mixed together. A problem is presented in that the powdered bread ingredients are exposed to humidity due to the water vapor in the case that powdered bread ingredients are put into a conventional additional-ingredients container. As a result, the powdered bread ingredients, for example, adhere to the additional-ingredients container, the amount of powdered bread ingredients to be automatically fed becomes inaccurate, and unsatisfactory bread is obtained. The shape and material of a conventional additional-ingredients container does not take the use of powders into account, and even when unaffected by water vapor, some of the bread ingredients are left behind on the sides of the additional-ingredients container. As a result, there is a problem in that unsatisfactory bread is made.

In view of the above, an object of the present invention is to provide an automatic bread maker that can make bread from cereal grains and that is convenient for the user to use. Another object of the present invention is to provide an automatic bread maker that can make bread from cereal grains and in which bread ingredients can be readily and automatically fed in a suitable fashion after the grinding step.

### Solution to Problem

In order to achieve the aforementioned object, an automatic bread maker according to the present invention comprises: a body in which a bread container is accommodated; a grinding mechanism for grinding cereal grains in the bread container accommodated in the body; a kneading mechanism for kneading into dough bread ingredients in the bread container accommodated in the body; and a bread ingredients storage container for storing powdered bread ingredients to be automatically fed into the bread container after the cereal grains have been ground by the grinding mechanism.

According to the present aspect, the powdered bread ingredients (e.g., gluten, dry yeast, and the like) are accommodated in the bread ingredients storage container in advance in the case that bread is to be baked from cereal grains, whereby, for example, the gluten, dry yeast, and other pulverulent bread ingredients can be automatically fed after the cereal grains have been ground. Therefore, according to the automatic bread maker of the present aspect, it is convenient for the user in that the user is not required to feed the powdered bread ingredients themselves.

Dry yeast is preferably included in the powdered bread ingredients. Also, any one among gluten, wheat flour, joshinko (top-grade rice flour made from non-glutinous rice), and guar gum is preferably included in the powdered bread ingredients.

In the automatic bread maker of the aspect described above, the bread-making steps performed when bread is made from cereal grains preferably include a grinding step for mixing the cereal grains with a liquid, and grinding the cereal grains using the grinding mechanism; and a kneading step for kneading into a dough the bread ingredients including ground flour obtained by the grinding step using the kneading mechanism.

In the automatic bread maker of the aspect described above, it is preferred that the rotational speed of the kneading blade be varied in the kneading step; and that, when the kneading blade is rotating slowly or when the kneading blade is not rotating, the powdered bread ingredients be automatically fed into the bread container in which the ground flour of the cereal grains has been put. It is also preferred that the powdered bread ingredients be automatically fed in the initial stage of the kneading step.

In the automatic bread maker of the aspect described above, the bread ingredients storage container may have: a container body having an aperture part; a lid body capable of opening and closing the aperture part, the lid body being swingably provided with respect to the container body; a seal member for sealing the space between the container body and the lid body in a state in which the aperture part has been closed by the lid body; and a lock mechanism for supporting the lid body from the outer surface side and maintaining the state in which the aperture part is closed.

According to the present aspect, the bread ingredients storage container provided to the automatic bread maker is configured so that the space between the container body and the lid body is sealed by the seal member in a state in which the aperture part is closed off. Accordingly, it is possible to minimize the entry into the bread ingredients storage container of moisture generated in the grinding step for grinding cereal grains. In the present configuration, it is preferred that the seal member be mounted on the container body. This makes it difficult for a situation to occur in which gluten and other bread ingredients catch on the seal member when the bread ingredients are automatically fed. Therefore, in the automatic bread maker of the present configuration, it is possible to minimize situations in which powder remains in the bread ingredients storage container and the amount of bread ingredients in the bread container becomes inaccurate when the gluten and other bread ingredients are automatically fed.

In the automatic bread maker of the aspect described above, the seal member is preferably secured to the container body so as to not protrude into the aperture part. In accordance with the present configuration, the possibility of the bread ingredients catching on the seal member can be further reduced in the case that lid body rotates and the aperture part of the bread ingredients storage container is opened. In other words, according to the present aspect, good quality bread is readily made because the amount of bread ingredients that remains in the bread ingredients storage container can be reduced.

In the automatic bread maker of the aspect described above, an inner surface of the container body and the lid body is preferably a smooth surface formed without concavities and convexities. In accordance with the present configuration, for example, the gluten, dry yeast, and other powdered bread ingredients readily slip down from the bread ingredients storage container into the bread container, and the amount of bread ingredients that remains in the bread ingredients storage container can be reduced.

In the automatic bread maker of the aspect described above, the container body and the lid body are preferably made of metal, and further, a coating layer is preferably formed on an inner surface of the container body and the lid body. In accordance therewith, for example, the gluten, dry yeast, and other powdered bread ingredients can readily slip down from the bread ingredients storage container into the bread container, and the amount of bread ingredients that remains in the bread ingredients storage container can be reduced. In the case that the lid body and the container body of the bread ingredients storage container are made of metal, the upper part and other parts of the bread can be reliably baked without non-uniformities because the bread ingredients storage container reflects heat in the baking step for baking the bread dough.

Aluminum is preferred as the metal used as the container body and the lid. The coating layer may be, e.g., a silicon- or fluorine-based coating layer, but a silicon based coating layer is preferred.

In the automatic bread maker of the aspect described above, the bread ingredients storage container further may have a cover member for securing the seal member to the container body; the lock mechanism may be provided to the cover member; and the lid body may be swingably mounted on the cover member. According to the present aspect, the bread ingredients storage container can be readily manufactured by using, e.g., a cover member made of resin.

In the automatic bread maker of the aspect described above, the cover member may be provided so as to cover the container body, and further, an air layer may be formed between the cover member and the container body. It is thus possible to obtain an insulating structure by covering the container body with the cover member and to reduce the possibility that powder stored in the bread ingredients storage container will adhere inside the container.

In the automatic bread maker of the aspect described above, it is preferred that the configuration further comprise a lock release mechanism for releasing a locked state produced by the lock mechanism, wherein the bread ingredients storage container is arranged so that the aperture part faces the aperture of the bread container; and by releasing the lock produced by the lock-release mechanism the lid body swings, the aperture part opens, and the bread ingredients stored in the bread ingredients storage container are fed into the bread container.

In the automatic bread maker of the aspect described above, the lock mechanism may include a lock member for supporting the lid body from the outer surface side and maintaining the state in which the aperture part is closed; and the lock release mechanism may press the lock member and release the locked state. In this aspect, the lock release mechanism may be intermittently driven in order to cause impact with the lock member after the locked state has been released. Using the so-configured aspect makes it possible to impart vibration to the bread ingredients storage container after the bread ingredients have dropped from the bread ingredients storage container, and to dramatically reduce the amount of bread ingredients that remains inside the bread ingredients storage container.

In the automatic bread maker of the aspect described above, the bread ingredients storage container may have: a storage part for storing the bread ingredients, the storage part being provided with a discharge port for discharging the bread ingredients into the bread container; a lid part for opening and closing the discharge port; a lock mechanism for maintaining a state in which the discharge port is closed by the lid part; a lock release mechanism for releasing the locked state produced by the lock mechanism; and a colliding part that collides with the storage part in a case where the locked state is released by the lock release mechanism and the discharge port is opened.

According to the present aspect, the bread ingredients storage container provided to the automatic bread maker is designed so that a collision is created between the storage part and the colliding part when the bread ingredients are fed into the bread container. It is possible to reduce the amount of gluten, dry yeast, and other powders that remain in the storage part because a shock is applied (a vibration is generated) to the storage part in accompaniment with the collision. In other words, in the automatic bread maker of the present aspect, it is possible to minimize situations in which flour remains in the bread ingredients storage container and the amount of bread ingredients in the bread container becomes inaccurate when the gluten and other bread ingredients are automatically fed.

In the automatic bread maker of the aspect described above, the colliding part may be a frame part arranged so as to surround the storage part, the colliding part moving relative to the storage part; and a collision may occur between the storage part and the frame part due to the relative movement in the case that the locked state has been released by the lock release mechanism and the discharge port has been opened. According to the present aspect, it is possible to form a bread ingredients storage container without an increase in size and in which powder is unlikely to be left behind.

In the automatic bread maker having the configuration described above, it is permissible to use a configuration in which, in a state in which the bread ingredients are fed from the bread ingredients storage container to the bread container, the frame part is securely arranged so that the aperture plane thereof is substantially parallel to the aperture plane of the bread container, and the storage part is arranged so that the discharge port faces the aperture of the bread container, the storage part being provided so as to be capable of movement in a direction substantially perpendicular to the aperture plane of the bread container; the lid part is swingably mounted on the frame part; a pair of first arm parts arranged substantially facing each other with the discharge port disposed therebetween is provided to a sidewall outer surface of the storage part, the first arm parts having a first cylindrical part that extends in a direction substantially parallel to the direction in which the storage part is capable of moving; a pair of second arm parts is provided to a sidewall outer surface of the frame part, the second arm parts being arranged substantially facing each other with an aperture of the sidewall outer surface disposed therebetween, and having a second cylindrical part that fits with the first cylindrical part and extends in a direction substantially parallel to the first cylindrical part; an urging member for urging the storage part toward the lid part is accommodated inside the first cylindrical part and the second cylindrical part in a state in which the discharge port has been closed by the lid part; and releasing of the locked state and the lid part rotating causes the storage part to move in the urging direction of the urging member, and the first arm parts and the second arm parts to collide.

According to the present aspect, the frame part is securely arranged and the storage part has a configuration that allows movement, thereby making it possible to obtain a configuration in which the frame part moves in a relative fashion with respect to the storage part, and a collision is obtained between the storage part and the frame part with the aid of the relative movement. In this configuration, the possibility that bread ingredients will remain in the storage part is readily reduced because the storage part side in which the bread ingredients are stored is moved.

In the automatic bread maker of the aspect described above, it is preferred that a sloped surface part be formed on the storage part so that the storage part can be pressed by the lid part and moved in a direction opposite the urging direction as a consequence of the lid part being caused to rotate in the case that the locked state has been released, the storage part has moved in the urging direction, and a part of the storage part is in a state of protruding from the frame part in the urging direction.

According to the present aspect, it is not required to perform an operation for first lifting the storage part and then rotating the lid part in order to close the discharge port of the storage part when the lid part of the bread ingredients storage container is to be closed. In other words, since the storage part can be lifted up simultaneously by the rotation of the lid part, the operation for closing the lid part of the bread ingredients storage container is facilitated, which is convenient for the user.

In the automatic bread maker of the aspect described above, an ingredient loading port that can be opened and closed in order for bread ingredients to be loaded may be provided to the storage part separately from the discharge port. It is thereby convenient for the user in that the bread ingredients can be put in a state in which the lid for opening and closing the discharge port is closed.

### Advantageous Effects of the Invention

In accordance with the present invention, it is possible to provide an automatic bread maker that can make bread from cereal grains and that is convenient for the user to use. Also, in accordance with the present invention, it is possible to provide an automatic bread maker that can make bread from cereal grains and in which bread ingredients can be readily and automatically fed in a suitable fashion after the grinding step. Therefore, it can be expected that bread-making at home will become more accessible and popular.

### BRIEF DESCRIPTION OF DRAWINGS

FIG. 1 is a vertical cross-sectional view of an automatic bread maker according to a first embodiment;

FIG. 2 is a partial vertical cross-sectional view of the automatic bread maker of the first embodiment shown in FIG. 1, cut at a right angle with respect to the view shown in FIG. 1;

FIG. 3 is a schematic perspective view for illustrating the configuration of a grinding blade and a kneading blade provided to the automatic bread maker of the first embodiment;

FIG. 4 is a schematic plan view for illustrating the configuration of a grinding blade and a kneading blade provided to the automatic bread maker of the first embodiment;

FIG. 5 is a top view of the bread container in the automatic bread maker of the first embodiment when the kneading blade is in the folded orientation;

FIG. 6 is a top view of the bread container in the automatic bread maker of the first embodiment when the kneading blade is in the open orientation;

FIG. 7 is a schematic plan view showing the state of the clutch in the automatic bread maker of the first embodiment when the kneading blade is in the open orientation;

FIG. 8 is a schematic perspective view showing a configuration of the bread ingredients storage container provided to the automatic bread maker of the first embodiment;

FIG. 9 is a schematic cross-sectional view in the A-A position of FIG. 8;

FIG. 10 is a control block diagram of the automatic bread maker of the first embodiment;

FIG. 11 is an illustrative diagram showing a flow of a rice grain bread-making procedure performed by the automatic bread maker according to the first embodiment;

FIG. 12A is a view for illustrating a circumstance in the automatic bread maker of the first embodiment wherein the locked state of the bread ingredients storage container is released by a solenoid, the bread ingredients storage container being shown in a locked state;

FIG. 12B is a view for illustrating a circumstance in the automatic bread maker of the first embodiment wherein the locked state of the bread ingredients storage container is released by a solenoid, the bread ingredients storage container having been released from the locked state;

FIG. 13 is a diagram showing a modified example of the configuration of the bread ingredients storage container provided to the automatic bread maker of the first embodiment;

FIG. 14A is a schematic perspective view as seen diagonally from above the bread ingredients storage container provided to the automatic bread maker of the second embodiment;

FIG. 14B is a schematic side view of the bread ingredients storage container provided to the automatic bread maker of the second embodiment as seen along the direction broken line arrow direction X shown in FIG. 14A;

FIG. 14C is a schematic plan view as seen from above the bread ingredients storage container provided to the automatic bread maker of the second embodiment;

FIG. 15A is a schematic cross-sectional view showing the configuration of the bread ingredients storage container provided to the automatic bread maker of the second embodiment, and is a cross-sectional view at the position D-D of FIG. 14B;

FIG. 15B is a schematic cross-sectional view showing the configuration of the bread ingredients storage container provided to the automatic bread maker of the second embodiment, and is a cross-sectional view at the position E-E of FIG. 14C;

FIG. 15C is a schematic cross-sectional view showing the configuration of the bread ingredients storage container provided to the automatic bread maker of the second embodiment, and is a view showing a state in which the feeding port lid part in FIG. 15A is open;

FIG. 16A is a schematic view for illustrating the operation of the bread ingredients storage container provided to the automatic bread maker of the second embodiment, and is a view showing the state in which the lid part in FIG. 15A is open; and

FIG. 16B is a schematic view for illustrating the operation of the bread ingredients storage container provided to the automatic bread maker of the second embodiment, and is a view showing the state in which the lid part in FIG. 15B is open.

### DESCRIPTION OF EMBODIMENTS

Embodiments of an automatic bread maker according to the present invention will be described in detail below with reference to the accompanying drawings. It is to be understood that any specific time, temperature, or other parameters that appear in this specification are merely examples and are not intended in any way to limit the content of the invention.

### First Embodiment

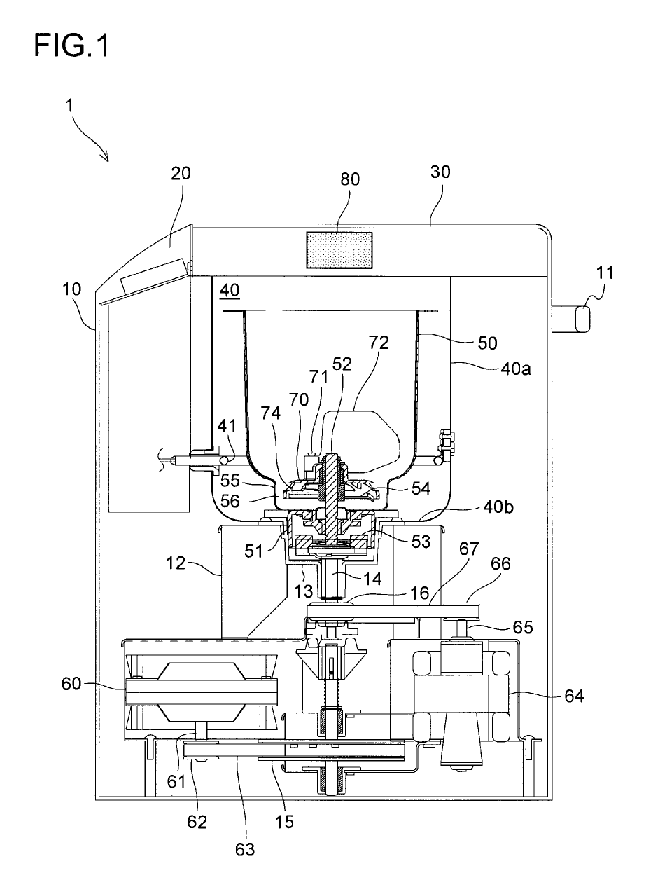

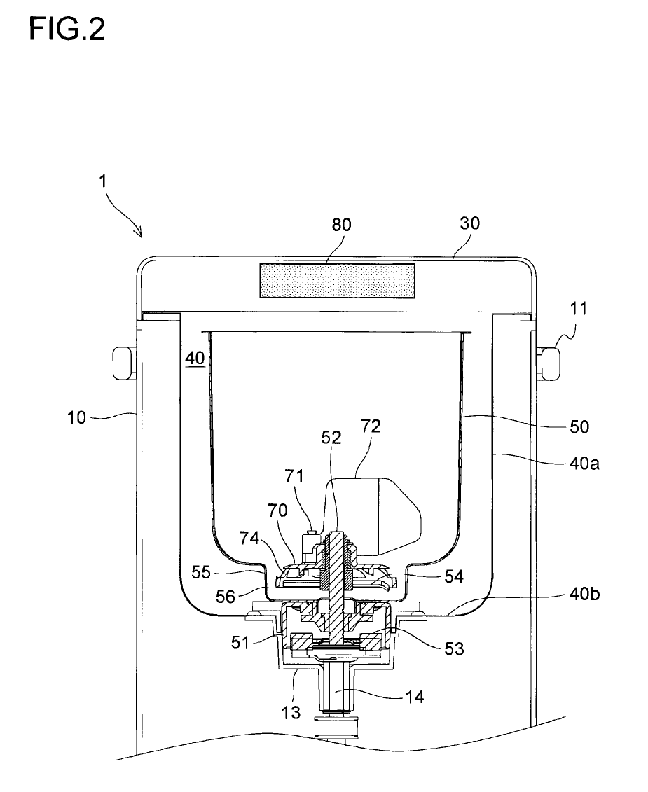

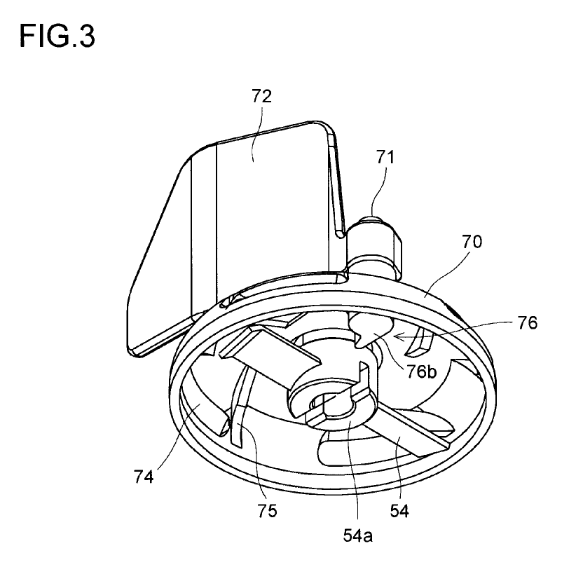

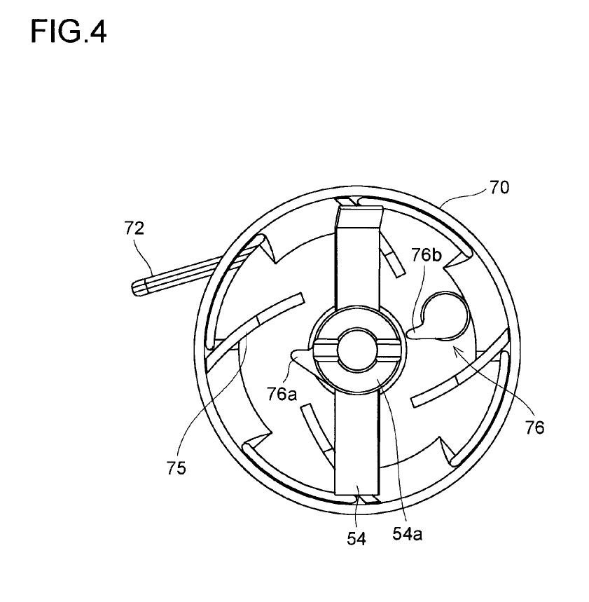

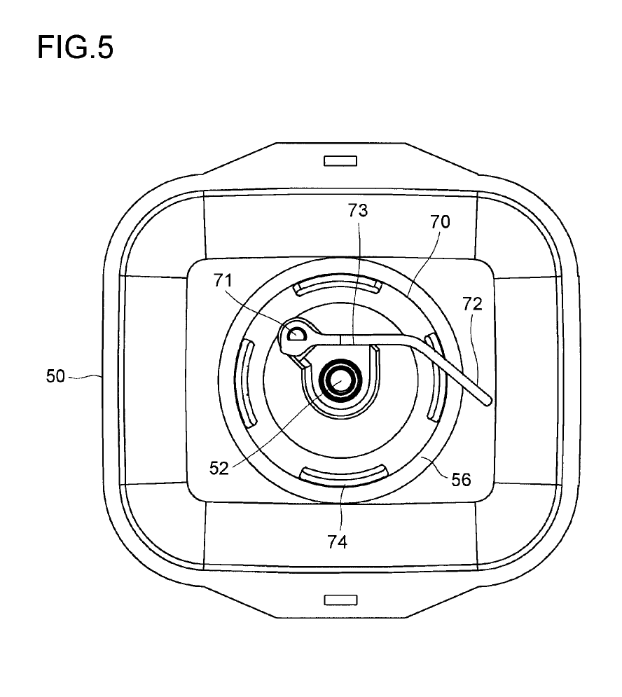

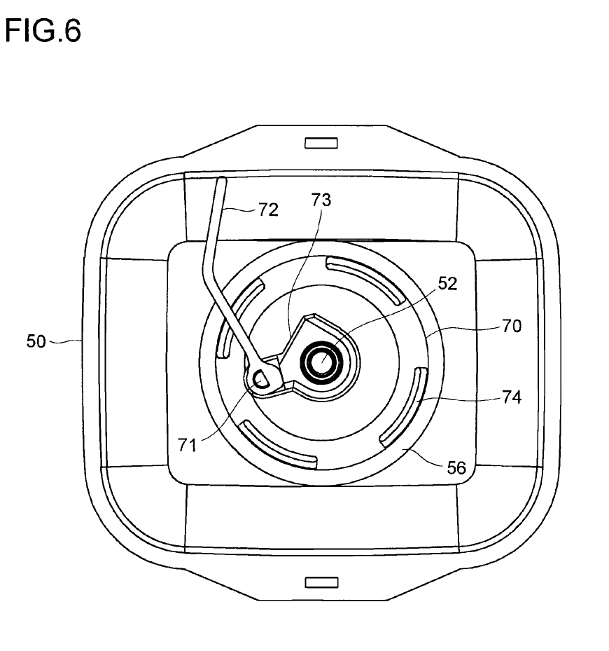

An automatic bread maker according to a first embodiment will be described first. FIG. 1 is a vertical cross-sectional view of an automatic bread maker according to a first embodiment. FIG. 2 is a partial vertical cross-sectional view of the automatic bread maker of the first embodiment shown in FIG. 1, cut at a right angle with respect to the view shown in FIG. 1. FIG. 3 is a schematic perspective view for illustrating the configuration of a grinding blade and a kneading blade provided to the automatic bread maker of the first embodiment, and is a view observed diagonally from the bottom. FIG. 4 is a schematic plan view for describing the configuration of the grinding blade and the kneading blade provided to the automatic bread maker of the first embodiment, and is a view observed from the bottom. FIG. 5 is a top view of the bread container in the automatic bread maker of the first embodiment when the kneading blade is in the folded orientation. FIG. 6 is a top view of the bread container in the automatic bread maker of the first embodiment when the kneading blade is in the open orientation. The configuration of an automatic bread maker 1 of the first embodiment will be described below mainly with reference to FIGS. 1 through 6.

In FIG. 1, the left side corresponds to the front (front surface), and the right side corresponds to the back (rear surface), of the automatic bread maker 1. Further, for an observer facing the automatic bread maker 1 from directly in front, the observer's left-hand side corresponds to the left side of the automatic bread maker 1, and the observer's right-hand side corresponds to the right side of the automatic bread maker 1.

The automatic bread maker 1 has a box-shaped body 10 made of a plastic shell. The body 10 is provided with plastic U-shaped handles 11 connected to the two ends of the left and right side surfaces of the body 10, whereby the automatic bread maker 1 can be readily transported. An operation part 20 is provided on the front part of the top surface of the body 10. Although not shown in the drawings, the operation part 20 is provided with an operating key group including a start key, a cancel key, a timer key, a reservation key, and a selection key for selecting a bread-making procedure (a procedure for making bread from rice grains, a procedure for making bread from rice flour, a procedure for making bread from wheat flour, and the like), and a display part that displays an item set by the operating key group, an error or the like. The display part is configured, for example, using a liquid crystal display panel and indicator lamps using light emitting diodes as light sources.

The top surface of the body behind the operation part 20 is covered by a plastic lid 30. The lid 30 is mounted to the back surface of the body 10 by a hinge shaft (not shown), and is configured to swing in a vertical plane about the hinge shaft. The lid 30 is provided with an observation window (not shown) made of heat-resistant glass to allow the user to view a baking chamber 40 (described hereafter) through the observation window.

The baking chamber 40, the planar shape of which is substantially rectangular, is provided inside the body 10. The baking chamber 40 is made of sheet metal with the top thereof open, and a bread container 50 is inserted into the baking chamber 40 through the opening. The baking chamber 40 comprises peripheral sidewalls 40a, the horizontal cross-section of which is rectangular, and a bottom wall 40b. A sheath heater 41 is arranged inside the baking chamber 40 so as to surround the bread container 50 accommodated in the baking chamber 40, thereby making it possible to heat the bread ingredients in the bread container 50. The sheath heater 41 is an example of heating means.

A base 12 made of sheet metal is disposed inside the body 10. A bread container support 13 made of a die-cast molding of an aluminum alloy is fixed at a location corresponding to the center of the baking chamber 40 in the base 12. The interior of the bread container support 13 is exposed within the baking chamber 40.

A motor shaft 14 is vertically supported at the center of the bread container support 13. The motor shaft 14 is caused to rotate via pulleys 15 and 16. A clutch is arranged between the pulley 15 and the motor shaft 14, and between the pulley 16 and the motor shaft 14. A system is therefore provided in which the rotation of the motor shaft 14 is not transmitted to the pulley 16 when the pulley 15 is caused to rotate in one direction and the rotation is transmitted to the motor shaft 14, and in which the rotation of the motor shaft 14 is not transmitted to the pulley 15 when the pulley 16 is caused to rotate in a direction opposite to that of the pulley 15 and the rotation is transmitted to the motor shaft 14.

The unit that causes the pulley 15 to rotate is the kneading motor 60 fixed to the base 12. The kneading motor 60 is a vertical shaft, and an output shaft 61 protrudes from the bottom surface thereof. A pulley 62 connected to the pulley 15 by a belt 63 is fixed to the output shaft 61. The kneading motor 60 is a low-speed/high-torque motor, and the pulley 62 causes the pulley 15 to rotate at a reduced speed. Therefore, the motor shaft 14 rotates at a low speed and high torque.

Similarly, a grinding motor 64 supported on the base 12 causes the pulley 16 to rotate. The grinding motor 64 is also a vertical shaft, and an output shaft 65 protrudes from the top surface thereof. A pulley 66 connected to the pulley 16 by a belt 67 is fixed to the output shaft 65. The grinding motor 64 serves to impart high-speed rotation to a grinding blade described hereafter. Therefore, a high-speed motor is selected for the grinding motor 64, and the speed reduction ratio of the pulley 66 and the pulley 16 is set at approximately 1:1.

The bread container 50 is made from sheet metal and has the shape of a bucket, there being a handle for gripping (not shown) mounted on the rim thereof. The horizontal cross-section of the bread container 50 is a rectangle with four rounded corners. A recess 55 is formed in the bottom part of the bread container 50 to accommodate a grinding blade 54 and a cover 70 (each described in detail hereafter). The recess 55 is a circular planar shape and is provided with a gap 56 between the external periphery of the cover 70 and the inside surface of the recess 55 to allow the flow of bread ingredients. Further, a cylindrical pedestal 51 made of a die-cast molding of an aluminum alloy is provided to the bottom surface of the bread container 50. The bread container 50 is disposed in the baking chamber 40 with the bread container support 13 accepting the pedestal 51.

A vertically extending blade rotation shaft 52 is supported at the center of the bottom part of the bread container 50 in a state in which sealing is applied. A rotary force is transmitted to the blade rotation shaft 52 from the motor shaft 14 via a coupling 53. Of the two members constituting the coupling 53, one member is fixed to the bottom end of the blade rotation shaft 52 and the other member is fixed to the top end of the motor shaft 14. The entirety of the coupling 53 is enclosed in the pedestal 51 and the bread container support 13.

Projections (not shown) are formed on the internal circumferential surface of the bread container support 13 and the external circumferential surface of the pedestal 51, and these projections constitute a known bayonet coupling. Specifically, when the bread container 50 is to be mounted on the bread container support 13, the projections on the pedestal 51 are kept from interfering with the projections on the bread container support 13, and the bread container 50 is lowered thereon. After the pedestal 51 is fitted into the bread container support 13, the projections of the pedestal 51 engage with the lower surfaces of the projections of the bread container support 13 when the bread container 50 twists horizontally. The bread container 50 is thereby prevented from slipping out upwards. Further, connection with the coupling 53 is simultaneously achieved by this operation.

The grinding blade 54 is mounted on the blade rotation shaft 52 at a location slightly above the bottom of the bread container 50. The grinding blade 54 is mounted on the blade rotation shaft 52 in a manner so as to be unable to rotate with respect to the blade rotation shaft 52. The grinding blade 54 is made of a stainless steel plate and has a shape such as that of an airplane propeller (this shape is merely an example) as shown in FIGS. 3 and 4. The center part of the grinding blade 54 is a hub 54a that fits onto the blade rotation shaft 52. A groove 54b is formed in the lower surface of the hub 54a so as to traverse the hub 54a in the diameter direction. In the case that the grinding blade 54 is fitted onto the blade rotation shaft 52 from above, a pin (not shown) that passes through the blade rotation shaft 52 in the horizontal direction receives the hub 54a and engages the groove 54b, and the grinding blade 54 is connected so as to be unable to rotate with respect to the blade rotation shaft 52. The grinding blade 54 is configured so as to be pulled away and separated from the blade rotation shaft 52, enabling cleaning to be performed after making bread and the grinding blade 54 to be simple to replace when the edge thereof becomes dull. The grinding blade 54 together with the grinding motor 64 are an embodiment of the grinding mechanism (grinding means) of the present invention.

A dome-shaped cover 70 having a circular planar shape is mounted on the top end of the blade rotation shaft 52. The cover 70 is made of a die-cast molding of an aluminum alloy. The cover 70 is held by a hub 54a of the grinding blade 54 (see FIGS. 3 and 4) and conceals the grinding blade 54. The cover 70 can also be easily pulled away from the blade rotation shaft 52, enabling cleaning to be readily performed after making bread.

A kneading blade 72, whose planar shape is a sideways V, is mounted on the top exterior surface of the cover 70. The kneading blade 72 is mounted on a vertically extending support shaft 71 arranged in a location separated from the blade rotation shaft 52. The kneading blade 72 is made of a die-cast molding of an aluminum alloy. The support shaft 71 is fixed to or integrated with the kneading blade 72 and moves with the kneading blade 72.

The kneading blade 72 swings about the support shaft 71 within the horizontal plane, and has a folded orientation shown in FIG. 5 and an open orientation shown in FIG. 6. In the folding orientation, the kneading blade 72 contacts a stopper 73 formed on the cover 70, and cannot swing any further in the clockwise direction relative to the cover 70. At this time, the tip of the kneading blade 72 protrudes slightly from the cover 70. In the open orientation, the tip of the kneading blade 72 is separated from the stopper 73 and protrudes significantly from the cover 70.

The kneading blade 72 together with the kneading motor 60 are an embodiment of the kneading mechanism (kneading means) of the present invention. There are formed in the cover 70 windows 74 linking the inner space of the cover to the outer space thereof, and ribs 75 provided to the inner surface of the cover 70 in correspondence with the respective windows 74, the ribs adapted for guiding towards the windows 74 ground ingredients ground by the grinding blade 54. This configuration improves the efficiency of the grinding in which the grinding blade 54 is used.

As shown in FIG. 4, for example, a clutch 76 is interposed between the cover 70 and the blade rotation shaft 52. The clutch 76 connects the blade rotation shaft 52 and the cover 70 in the rotation direction of the blade rotation shaft 52 when the kneading motor 60 causes the motor shaft 14 to rotate (this rotation direction is the “forward direction rotation,” and is the clockwise rotation direction in FIG. 4). Conversely, the clutch 76 disconnects the blade rotation shaft 52 from the cover 70 in the rotation direction of the blade rotation shaft 52 when the grinding motor 64 causes the motor shaft 14 to rotate (this rotation direction is the “reverse direction rotation,” and is the counter-clockwise rotation direction in FIG. 4). In FIGS. 5 and 6, the “forward direction rotation” is the counter-clockwise rotation direction and the “reverse direction rotation” is the clockwise rotation direction.

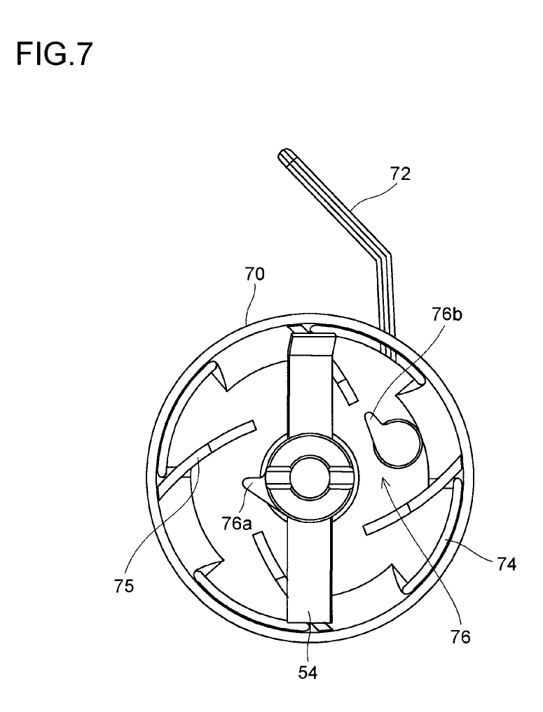

The clutch 76 switches the connection states according to the orientation of the kneading blade 72. That is, when the kneading blade 72 is in the folded orientation as shown in FIG. 5, a second engaging body 76b (which is, for example, fixed to the support shaft 71) interferes with the rotation path of a first engaging body 76a (which is, for example, fixed to the hub 54a of the grinding blade 54) as shown in FIG. 4. Therefore, the first engaging body 76a and the second engaging body 76b engage when the blade rotation shaft 52 rotates in the forward direction, and the rotary force of the blade rotation shaft 52 is transmitted to the cover 70 and the kneading blade 72. In contrast, when the kneading blade 72 is in the open orientation as shown in FIG. 6, the second engaging body 76b departs from the rotation path of the first engaging body 76a, as shown in FIG. 7. Therefore, even when the blade rotation shaft 52 rotates in the reverse direction, the first engaging body 76a and the second engaging body 76b do not engage with each other. The rotary force of the blade rotation shaft 52 accordingly is not transmitted to the cover 70 and the kneading blade 72. FIG. 7 is a schematic plan view showing the state of the clutch when the kneading blade is in the open orientation.

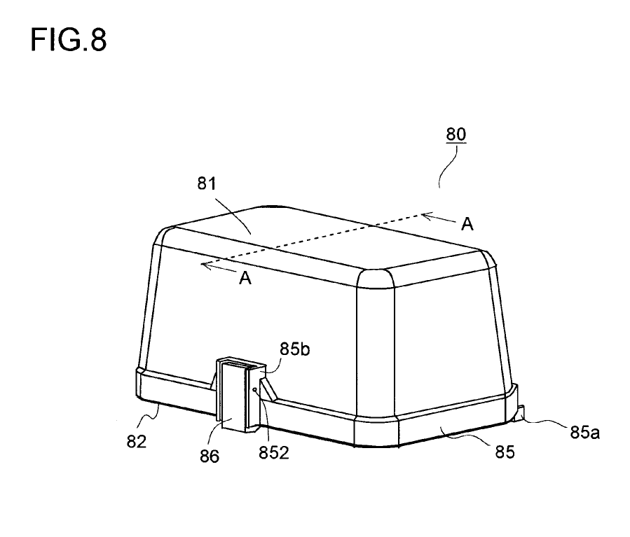

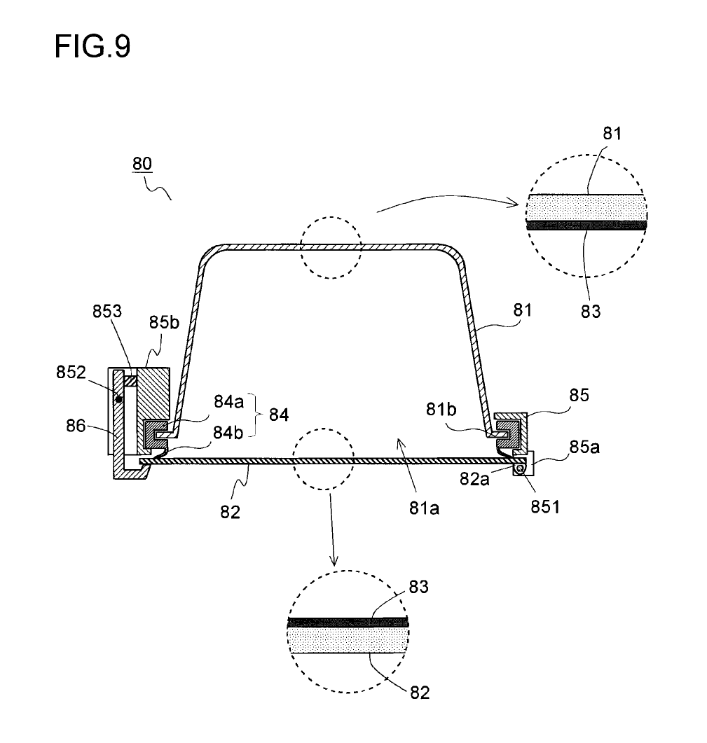

Returning to FIGS. 1 and 2, the automatic bread maker 1 of the first embodiment is provided with a bread ingredients storage container 80 mounted on the lid 30. The present embodiment is configured with the bread ingredients storage container 80 mounted on the lid 30, but it is also possible to use a configuration in which the bread ingredients storage container is mounted on the body 10 depending on the case. The bread ingredients storage container 80 is a container provided so that a portion of the bread ingredients can be automatically fed into the bread container 50 while a bread-making procedure for baking bread is being performed. The configuration of the bread ingredients storage container 80 is described below with reference to FIGS. 8 and 9. FIG. 8 is a schematic perspective view showing a configuration of the bread ingredients storage container provided to the automatic bread maker of the first embodiment. FIG. 9 is a schematic cross-sectional view in the A-A position of FIG. 8.

The bread ingredients storage container 80 mainly comprises a container body 81 and a lid body 82 that can open and close an aperture part 81a present on the container body 81, as shown in FIGS. 8 and 9.

The container body 81 is a box-shaped member having a substantially trapezoidal cross-sectional shape, and more specifically, the portions that connect the side walls and bottom wall (the bottom wall is oriented upward in FIGS. 8 and 9) constituting the container body 81 and the portions that connect the side walls together are rounded. Accordingly, the side and bottom surfaces and side surfaces are smoothly joined without bending sharply in the inner surface side of the container body 81. The planar shape of the aperture part 81a of the container body 81 is substantially rectangular with rounded corners. A guard part (flange part) 81b is formed on the container body 81 so as to project outward from the side edge of the aperture part 81a, as shown in FIG. 9. The guard part 81b is frame shaped with rounded corners when the container body 81 is viewed from the aperture part 81a side.

The container body 81 configured in this manner is formed from aluminum, iron, or another metal (including alloys) having a thickness of about, e.g., 1.0 mm. A coating layer 83 based on silicon, fluorine, or the like is provided to the inner surface of the container body 81, as shown in FIG. 9. The metal constituting the container body 81 is not meant to be limited to the given examples, but aluminum is preferably used because the container body 81 will be readily formed as well as for other reasons. The coating layer 83 provided to the inner surface of the container body 81 is not meant to be limited to the given examples, but a silicon-based coating layer is preferred.

The bread ingredients storage container 80 described above is used for automatically feeding a portion of the bread ingredients into the bread container 50. Accordingly, the bread ingredients storage container 80 must be configured so that the bread ingredients stored therein are fed into the bread container 50 without as little as possible of the bread ingredients being left in the container. Specific examples of the bread ingredients that are stored in the bread ingredients storage container 80 include gluten, dry yeast, and other powders. Since gluten and other powders readily adhere to the container body 81, the container body 81 must be configured so that gluten and other powders are unlikely to do so.

In consideration of the above, the container body 81 is preferably made of aluminum or another metal rather than a resin, which readily possesses an electrostatic charge. More preferred than merely using a metal container body 81 is providing a coating layer 83 based on silicon, fluorine, or the like as in the present embodiment in order to improve slippage of the powders. The coating layer 83 is baked or otherwise formed on the inner surface of the container body 81. In the case that a fluorine-based substance is used as the coating layer 83, the baking temperature is higher than in the case that a silicon-based substance is used (e.g., about 300° C. in the case that a fluorine-based substance is used, and about 200° C. in the case that a silicon-based substance is used). In the case that the container body 81 is formed using aluminum, the temperature during baking is excessively high when a fluorine-based substance is used as the coating layer 83, and the strength of the container body 81 is reduced. Accordingly, a silicon-based substance is preferably used as the coating layer 83 in the case that the container body 81 is configured using aluminum.

Based on the desire that gluten and other powders be less liable to adhere to the inner surface of the container body 81, the inner surface of the container body 81 is a smooth surface on which concavities and convexities are not formed and rivets, screws and other protrusions are not provided. As described above, the side and bottom surfaces and the side surfaces of the container body 81 are configured so as to be smoothly joined without sharp bends, the purpose of such design being to make the gluten and other powders less likely to adhere.

Packing 84 made of silicon, for example, is secured to the guard part 81b of the container body 81, as shown in FIG. 9. The packing 84 made of silicon is an embodiment of the seal member of the present invention. The external appearance of the packing 84 is substantially the form of a frame with a planar shape. The packing 84 is configured having a cross-sectional U-shaped mounting part 84a mounted on the container body 81 so as to hold the guard part 81b from above and below, and a thin elastic part 84b folded back so as to protrude from below the mounting part 84a and face the opposite direction from the direction facing the aperture part 81a, as shown in FIG. 9. The packing 84 is secured to the container body 81 by a cover member 85 that is arranged so as to cover the U-shaped mounting part 84a and retains the packing 84 together with the guard part 81b. The material of the cover member 85 is not particularly limited, but an example is polybutylene terephthalate (PBT) in which glass filler has been dispersed.

A lid body support part 85a (refer to FIGS. 8 and 9) for swingably supporting the lid body 82, which is composed of a flat metal plate, is formed at two ends of one of the two long sides of the cover member 85, which is formed substantially the form of a frame with a planar shape. An engagement part 82a (refer to FIG. 9) for engaging an engagement protrusion 851 (refer to FIG. 9) that protrudes from the lid body support part 85a is provided at two ends of one of the two long sides of the lid body 82, which has a substantially rectangular planar shape. In other words, the lid body 82 is swingably supported by the cover member 85 about the engagement protrusion 851 (in FIG. 9, the lid body 82 swings in the plane of the page).

A clamp hook support part 85b for swingably supporting a clamp hook 86 (an embodiment of the lock member of the present invention) is provided substantially in the center part of the long side of the cover member 85 on which the lid body support part 85a is not formed. The clamp hook support part 85b has a groove shape that extends in a direction (vertical direction of FIG. 9) substantially parallel to the depth direction of the container body 81. A shaft 852 is mounted on the clamp hook support part 85b so that the two ends of the shaft 852 are secured by the two opposing sidewalls, and the clamp hook 86 is swingably supported by the shaft 852. As shown in FIG. 9, a spring 853 for urging the clamp hook 86 outward (leftward in FIG. 9) is mounted on the bottom surface above the shaft 852 of the clamp hook support part 85b provided in shape of a groove.

A portion of the clamp hook 86 having one of the distal-end sides (the lower side in FIG. 9) provided in the form of a hook is thereby caused to make contact with the outer surface (lower surface) of the lid body 82 to support the lid body 82, making it possible for the lid body 82 to maintain the aperture part 81a of the container body 81 in a closed state (the state shown in FIGS. 8 and 9, corresponding to the locked state of the present invention). In a state in which the aperture part 81a of the container body 81 is closed, the lid body 82 completely covers the aperture part 81a with the external circumferential surface part superimposed on the guard part 81b of the container body 81.

The other distal-end side (upper side in FIG. 9) of the clamp hook 86 is pressed from the exterior toward the container body 81 side (right side of FIG. 9), whereby the locked state of the clamp hook 86 is released (support of the lid body 82 by the clamp hook 86 is released) and the lid body 82 can be swung to achieve a state in which the aperture part 81a is opened.

In the present embodiment, the clamp hook 86, the clamp hook support part 85b, the shaft 852, and the spring 853 are an embodiment of the lock mechanism of the present invention. A mounting part (not shown) for securing the bread ingredients storage container 80 to the lid 30 of the automatic bread maker 1 is formed on the cover member 85.

The lid body 82 composed of a flat metal plate (having, e.g., a thickness of about 1.0 mm) is preferably formed using aluminum, as is the container body 81, and the coating layer 83 composed of a silicon-base substance or the like is preferably formed on the inner surface (upper surface in FIG. 9) of the lid body 82 as seen in the enlarged view shown in FIG. 9.

In the case that the lid body 82 has closed the aperture part 81a of the container body 81 with the aid of the lock mechanism (the state shown in FIGS. 8 and 9), the elastic part 84b of the packing 84 is in constant contact with the inner surface (upper surface in FIG. 9) of the lid body 82. Therefore, in the state in which the lid body 82 has closed the aperture 81b, the space between the lid body 82 and the guard part 81b of the container body 81 is sealed by the packing 84; and moisture, dust, and the like have difficultly entering from the exterior into the container body 81.

The packing 84 secured to the guard part 81b of the container body 81 is provided so as to not protrude into the aperture 81a, as shown in FIG. 9. This design was made with consideration given to the fact that the bread ingredients stored in the bread ingredients storage container 80 catch on the packing 84 and remain inside the bread ingredients storage container 80 when the packing 84 protrudes into the aperture part 81a, and the amount of fed bread ingredients becomes unsuitable. The packing 84 is secured to the container body 81 side because if the packing 84 is secured to the lid body 82 side, the bread ingredients catch on the packing 84 and the amount of fed bread ingredients becomes unsuitable when the bread ingredients are fed from the bread ingredients storage container 80 to the bread container 50.

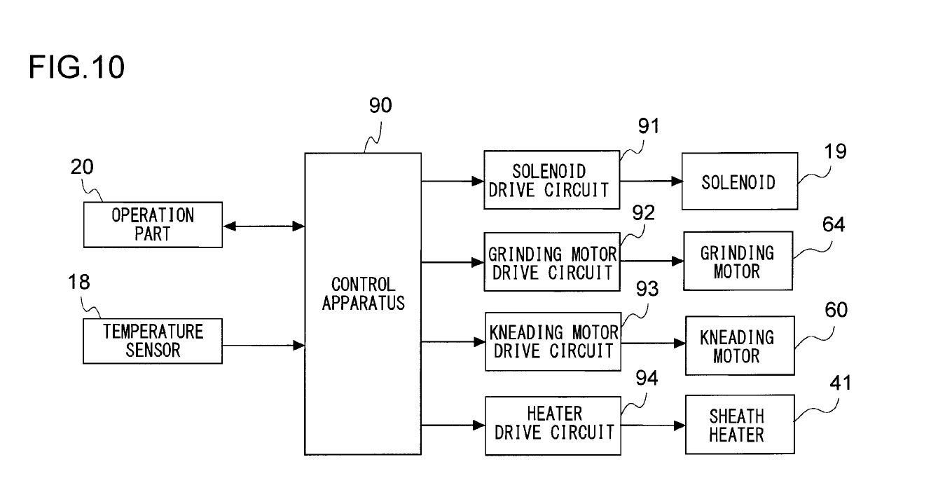

FIG. 10 is a control block diagram showing the automatic bread maker of the first embodiment. A control apparatus 90 controls the operation of the automatic bread maker 1, as shown in FIG. 10. The control apparatus 90 is configured using, for example, a microcomputer composed of a central processing unit (CPU), read only memory (ROM), random access memory (RAM), input/output (I/O) circuitry, and other components. The control apparatus 90 is preferably arranged in a position unlikely to be affected by the heat of the baking chamber 40. Further, the control apparatus 90 comprises a time measurement function, making it possible to perform time control in the bread-making step.

The operation part 20 described above, a temperature sensor 18, a solenoid drive circuit 91, a grinding motor drive circuit 92, a kneading motor drive circuit 93, and a heater drive circuit 94 are electrically connected to the control apparatus 90. The temperature sensor 18 is a sensor provided so that the temperature of the baking chamber 40 can be detected.

The solenoid drive circuit 91 is a circuit for controlling the driving of a solenoid 19 under instruction from the control apparatus 90. The solenoid 19 is provided for releasing the lock mechanism provided to the bread ingredients storage container 80 described above; and is, e.g., mounted on the lid 30 of the automatic bread maker 1. However, the solenoid 19 may be mounted on the body 10 depending on the case. When the solenoid 19 is driven, the amount the plunger protrudes from the housing is increased. The clamp hook 86 constituting the lock mechanism is pressed by the plunger or the movable member that is pressed by the plunger to allow movement, and the locked state of the lock mechanism is released. The solenoid 19 is an embodiment of the lock release mechanism (lock release means) of the present invention.

The grinding motor drive circuit 92 is a circuit for controlling driving of the grinding motor 64 under instruction from the control apparatus 90. The kneading motor drive circuit 93 is a circuit for controlling driving of the kneading motor 60 under instruction from the control apparatus 90. The heater drive circuit 94 is a circuit for controlling the operation of the sheath heater 41 under instruction from the control apparatus 90.

The control apparatus 90 reads a program related to the bread-making procedure stored in the ROM or the like on the basis of an input signal from the operation part 20, and causes the automatic bread maker 1 to carry out bread-making steps while controlling the driving of the solenoid 19 via the solenoid drive circuit 91, the rotation of the grinding blade 54 via the grinding motor drive circuit 92, the rotation of the kneading blade 72 via the kneading motor drive circuit 93, and the heating operation of the sheath heater 41 via the heater drive circuit 94.

Described next is the operation for the case in which a bread-making procedure (bread-making procedure for rice grains) for making (baking) bread from rice grains (one form of cereal grains) is performed by the automatic bread maker 1 of the first embodiment configured in the manner described above. The automatic bread maker 1 of the first embodiment is provided so as to be capable of a bread-making procedure for baking bread using wheat flour or rice flour as a bread ingredient, but the present invention is characterized by a system in which cereal grains (rice grains) are ground and the remaining bread ingredients are automatically fed thereafter. Therefore, only the operation for carrying out a bread-making procedure for rice grains will be described.

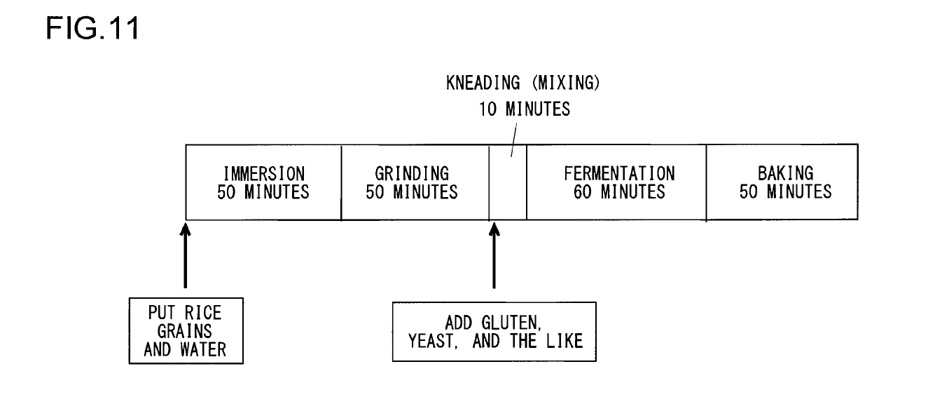

FIG. 11 is an illustrative diagram showing a flow of a rice grain bread-making procedure performed by the automatic bread maker of the first embodiment. In the rice grain bread-making procedure, the following steps are sequentially performed in the following order: an immersion step, a grinding step, a kneading (mixing) step, a fermentation step, and a baking step, as shown in FIG. 11.

A user mounts the grinding blade 54 and the cover 70, on which the kneading blade 72 is attached, in the bread container 50 in order to perform the rice grain bread-making procedure. The user then measures the respective predetermined amounts of rice grains and water and puts them in the bread container 50. Here, rice grains and water are mixed, but a liquid having a taste component such as a soup stock, fruit juice, a liquid containing alcohol, or another liquid, for example, may be used in place of plain water.

The user measures a predetermined amount of each of the bread ingredients (ordinarily, a plurality) other than rice grains and water, and puts the bread ingredients into the container body 81 of the bread ingredients storage container 80. The user stores the bread ingredients that need to be stored in the container body 81, then arranges the lid body 82 so as to close off the aperture part 81a of the container body 81, and supports the lid body 82 with the clamp hook 86 to achieve a locked state.

Examples of the bread ingredients stored in the bread ingredients storage container 80 include gluten, dry yeast, salt, sugar, and shortening. Instead of gluten, it is possible store, e.g., wheat flour, joshinko, or thickener (guar gum or the like) in the bread ingredients storage container 80. It is also possible to store, e.g., dry yeast, salt, sugar, and shortening in the bread ingredients storage container 80 without the use of gluten, wheat flour, joshinko, and a thickener. In some cases, it is possible to put, e.g., salt, sugar, and shortening together with the rice grains to the bread container 50, and to store only, e.g., gluten and dry yeast in the bread ingredients storage container 80.

The user thereafter places the bread container 50, into which the rice grains and water have been put, into the baking chamber 40, mounts the bread ingredients storage container 80 in a predetermined position, closes the lid 30, selects a rice grain bread-making procedure using the operation unit 20, and presses the start key. This starts the rice grain bread-making procedure for making bread from the rice grains.

The bread ingredients storage container 80 is arranged so that at least a portion of the aperture part 81a faces the aperture of the bread container 50 in a state in which the aperture part 81a has been opened. In the case of a configuration in which only a part of the aperture part 81a faces the aperture of the bread container 50, it is necessary to ensure that the bread ingredients are fed into the bread container 50 without leaking to the exterior of the bread container 50. An example of such an arrangement is to configure the bread ingredients storage container 80 so that the lid body 82 makes contact with the edge of the bread container 50 when the lid body has been unlocked, swung, and set in a diagonal state, and so that the bread ingredients are fed into the bread container 50 while sliding over the lid body 82.

When the rice-grain bread-making procedure is started, the immersion step is started by instruction from the control apparatus 90. In the immersion step, the mixture of rice grains and water is left in a stationary state, and the stationary state is maintained for a predetermined time (50 minutes in the present embodiment) set in advance. In the immersion step, the rice grains are soaked with water, which is performed to facilitate the grinding of the rice grains to the cores in the grinding step performed subsequently.

The water-absorption speed of the rice grains varies with the water temperature. That is, the water-absorption speed increases with a high water temperature and decreases with a low water temperature. Accordingly, the time of the immersion step may be varied in accordance with, e.g., the ambient temperature in which the automatic bread maker 1 is used and other parameters. Variability in the water absorption of the rice grains can thereby be minimized. It is possible to energize the sheath heater 41 during the immersion step to increase the temperature of the baking chamber 40 in order to shorten the immersion time.

In the immersion step, the grinding blade 54 may be caused to rotate in the initial stage and caused to rotate intermittently thereafter. Such a configuration makes it possible to scar the surfaces of the rice grains, improving the liquid-absorption efficiency of the rice grains.

When the above-noted predetermined time has elapsed, the immersion step is ended and the grinding step for grinding the rice grains is started by instruction from the control apparatus 90. In the grinding step, the grinding blade 54 is rotated at high speed in the mixture of rice grains and water. Specifically, the control apparatus 90 controls the grinding motor 64, rotating the blade rotation shaft 52 in the reverse direction and starting the grinding blade 54 rotating in the mixture of rice grains and water. In this event, the cover 70 also starts to rotate in association with the rotation of the blade rotation shaft 52, but the following operation immediately stops the rotation of the cover 70.

The rotation direction of the cover 70 accompanying the rotation of the blade rotation shaft 52 for rotating the grinding blade 54 is clockwise in FIG. 5, and, in a case that the kneading blade 72 has been in the folded orientation (the orientation shown in FIG. 5), the kneading blade 72 is changed to the open orientation (the orientation shown in FIG. 6) by resistance from the mixture of the rice grains and water. When the kneading blade 72 moves to the open orientation, the second engaging body 76b departs from the rotation path of the first engaging body 76a, and therefore the clutch 76 disconnects the blade rotation shaft 52 from the cover 70 as shown in FIG. 7. At the same time, the kneading blade 72 in the open orientation hits the inner wall of the bread container 50 as shown in FIG. 6, stopping the rotation of the cover 70.

In the grinding step, the rice grains are ground in a state in which water has permeated the rice grains by the preceding immersion step, and therefore the rice grains can be readily ground to their cores. Rotation of the grinding blade 54 in the grinding step occurs intermittently. This intermittent rotation is performed, e.g., in a cycle in which rotation occurs for 30 seconds and is stopped for five minutes, and the cycle is repeated 10 times. In the final cycle, the five-minute stoppages are not performed. The rotation of the grinding blade 54 may be continuous, but intermittent rotation is preferred in order, e.g., to prevent the temperature of the ingredients in the bread container 50 from becoming excessively high, and for other purposes.

The grinding step is ended in a predetermined length of time (50 minutes in the present embodiment) in the automatic bread maker 1. However, the hardness of the rice grains may vary, and the granularity of the ground flour may vary depending on ambient conditions. Therefore, it is possible to use a configuration in which the magnitude of the load (which can be determined by, e.g., the control current or the like of the motor) on the grinding motor 64 during grinding is used as an indicator for determining the end of the grinding step.

In the grinding step, heat is generated by friction between the rice grains and the grinding blade 54 when the rice grains are ground, and the moisture inside the bread container 50 is more readily evaporated away. In this case, there is concern that moisture will penetrate the bread ingredients storage container 80 arranged above the bread container 50, and that the bread ingredients will adhere to the bread ingredients storage container 80 and will not readily drop from the bread ingredients storage container 80 when the later-described bread ingredients are automatically fed. However, the bread ingredients storage container 80 is capable of minimizing such adhering of the bread ingredients to the container because moisture penetration is less likely due to the packing 84.

When the grinding step is ended, the kneading step is started by instruction from the control apparatus 90. The kneading step must be performed at a temperature (e.g., about 30° C.) at which the yeast can actively work. Therefore, the kneading step may be started when a predetermined temperature range has been reached.

When the kneading step is started, the control apparatus 90 controls the kneading motor 60 so as to cause the blade rotation shaft 52 to rotate in the forward direction. The grinding blade 54 is rotated in the forward direction by the rotation of the blade rotation shaft 52, and the bread ingredients around the grinding blade 54 flow in the forward direction, whereby the cover 70 is rotated in the forward direction (the counterclockwise direction in FIG. 6) in accompaniment therewith. When the cover 70 rotates in the forward direction, the kneading blade 72 changes from an open orientation (refer to FIG. 6) to a folded orientation (refer to FIG. 5) under resistance from the bread ingredients (a mixture of ground rice grain flour and water at this stage) inside the bread container 50. As a result, the clutch 76 forms an angle that causes the second engaging body 76b to interfere with the rotation path of the first engaging body 76a, thus connecting the blade rotation shaft 52 to the cover 70 as shown in FIG. 4. This causes the cover 70 and kneading blade 72 to integrally rotate in the forward direction with the blade rotation shaft 52. The kneading blade 72 rotates at a slow speed and high torque.

The rotation of the kneading blade 72 is initially extremely slow in the kneading step, and the speed is increased in a stepwise fashion under the control of the control apparatus 90. In the initial stage of the kneading step in which the rotation of the kneading blade 72 is extremely slow, the control apparatus 90 drives the solenoid 19 and releases the locked state of the lock mechanism provided to the bread ingredients storage container 80. Gluten, dry yeast, salt, sugar, shortening and other such bread ingredients are thereby automatically fed into the bread container 50.

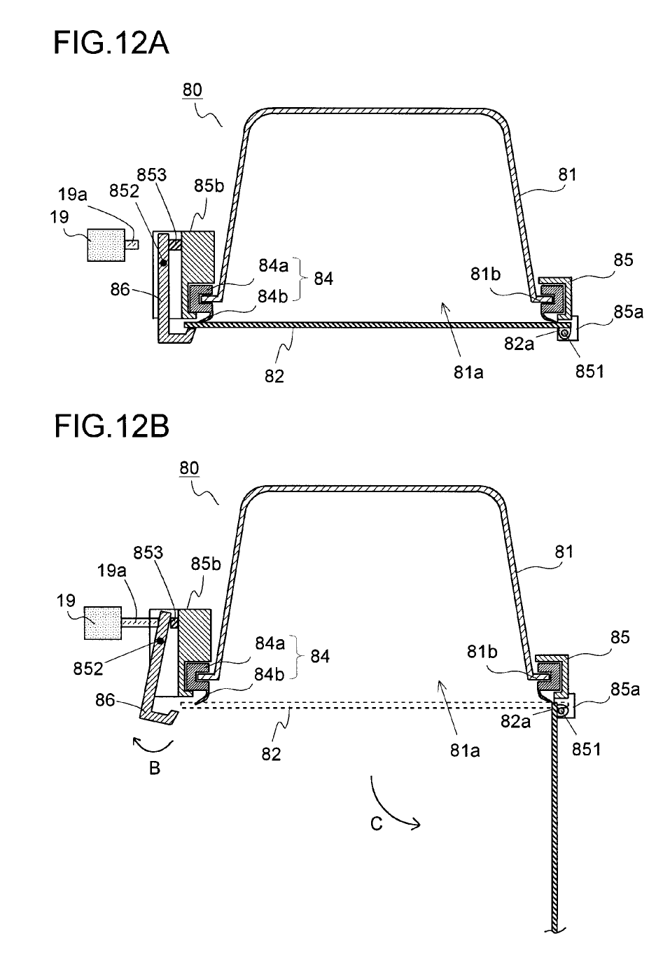

FIGS. 12A and 12B are views for illustrating the circumstance in which the locked state of the bread ingredients storage container is released by a solenoid, wherein FIG. 12A is a view of the case in which the bread ingredients storage container is in a locked state, and FIG. 12B is a view of the case in which the locked state of the bread ingredients storage container has been released. When the solenoid 19 is driven by instruction from the control apparatus 90, the upper part of the clamp hook 86 is pressed by a plunger 19a of the solenoid 19 and the clamp hook 86 swings in the arrow B direction about the shaft 852, as shown in FIGS. 12A and 12B. The engagement of the clamp hook 86 and the lid body 82 is thereby released and the lid body 82 swings in the arrow C direction. When the lid body 82 swings, the aperture part 81a of the container body 81 is opened and the bread ingredients therefore drop into the bread container 50 below the bread ingredients storage container 80.

A preferred configuration is one in which the position of the lid body 82 after the aperture part 81a has opened is a position that is not in contact with the bread dough in the fermentation step that is performed thereafter.

As described above, the bread ingredients storage container 80 is designed so that a coating layer 83 is provided to the interior of the container body 81 and the lid body 82 to improve slipping characteristics, and concavities and convexities are not provided to the interior. Further, a situation in which the bread ingredients catch on the packing 84 is minimized by the method in which the packing 84 is arranged. Therefore, the bread ingredients substantially do not remain in the bread ingredients storage container 80.

Even with the above-described designs, it is still possible for the bread ingredients to remain adhering inside the bread ingredients storage container 80. Therefore, the solenoid 19 may be intermittently driven to knock the clamp hook 86 (to cause an impact with the clamp hook 86) and impart vibrations to the bread ingredients storage container 80 to cause the bread ingredients remaining in the container to drop. The timing for driving the solenoid 19 is preferably one when the upper part of the clamp hook 86 has approached the solenoid 19 side due to the urging force of the spring 853.

In the present embodiment, the bread ingredients stored in the bread ingredients storage container 80 are fed into the bread container 50 in a state in which the kneading blade 72 is rotating. However, no limitation is imposed thereby, and it is also possible for the bread ingredients stored in the bread ingredients storage container 80 to be fed into the bread container 50 in a state in which the kneading blade 72 is stopped. However, in terms of uniformly dispersing the bread ingredients, it is preferred that the bread ingredients be fed in a state in which the kneading blade 72 is rotating in the manner of the present embodiment.

After the bread ingredients stored in the bread ingredients storage container 80 have been fed into the bread container 50, the bread ingredients are kneaded inside the bread container 50 by the rotation of the kneading blade 72 to become an integrated ball of dough having a predetermined elasticity. The kneading blade 72 tosses the dough about and beats it against the inner wall of the bread container 50, adding the element of “working” to the kneading. The cover 70 also rotates with the rotation of the kneading blade 72. When the cover 70 rotates, the bread ingredients inside the cover 70 are rapidly discharged from the windows 74 and are assimilated into the mass of bread ingredients (dough) being kneaded by the kneading blade 72 because the ribs 75 formed in the cover 70 also rotate.

In the automatic bread maker 1, the time for the kneading step is a predetermined time (e.g., 10 minutes) determined by experimentation as the time required to obtain a bread dough having the desired elasticity. However, when the time for the kneading step is fixed, the quality of the bread dough may vary due to ambient temperature or another factor. Therefore, it is possible use a configuration in which the magnitude of, e.g., the load (which can be determined by, e.g., the control current or the like of the motor) on the kneading motor 60 is used as an indicator for determining the end of the kneading step.

When bread containing additional ingredients (e.g., raisins, nuts, cheese) is baked, the additional ingredients are added by hand by the user during the kneading step. Such additional ingredients may be added at the same time as the gluten, yeast, or the like in the bread ingredients storage container 80, but it is not preferred that the additional ingredients become mashed when the additional ingredients are added at an early stage of the kneading step. Therefore, it is preferred that the additional ingredients be added into the bread container 50 at a later timing apart from the gluten, dry yeast, and the like.

When the kneading step is ended, a fermentation step is started according to an instruction from the control apparatus 90. In the fermentation step, the control apparatus 90 controls the sheath heater 41 and sets the temperature of the baking chamber 40 to a temperature (e.g., 38° C.) that promotes fermentation. The dough is left standing for a predetermined time (60 minutes in the present embodiment) in an environment that promotes fermentation.

Depending on the situation, a process such as rotating the kneading blade 72 to deflate or round the dough may be performed during the fermentation step.

When the fermentation step is ended, a baking step is started by an instruction from the control apparatus 90. The control apparatus 90 controls the sheath heater 41 and increases the temperature of the baking chamber 40 to a temperature (e.g., 125° C.) suitable for baking bread. The bread is baked for a predetermined time (50 minutes in the present embodiment) in a baking environment. The user is notified of the end of the baking step, e.g., by a display on a liquid crystal display panel, an audio alert, or the like (neither is shown) on the operation part 20. When the bread-making is detected to be complete, the user opens the lid 30 and removes the bread container 50 to complete the bread making.

The automatic bread maker of the first embodiment is configured so that the bread ingredients storage container 80 is arranged on the lid 30 and the container body 81 and the lid body 82 are formed from metal. Therefore, in the baking step, heat is readily reflected by the bread ingredients storage container 80 and baking non-uniformities on the top surface or the like of the bread can be prevented.

As described above, the automatic bread maker 1 of the first embodiment makes it possible to bake bread from rice grains, providing great convenience. It is convenient for the user because, e.g., the gluten, dry yeast, and other powdered bread ingredients can be accurately and automatically fed after the rice grains have been ground.

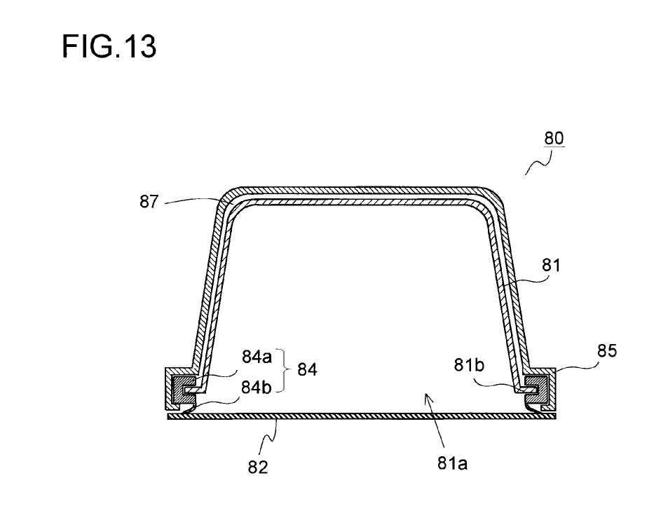

The bread ingredients storage container 80 described above may be modified to a configuration such as that shown in FIG. 13. In the modified example shown in FIG. 13, the cover member 85 of the bread ingredients storage container 80 is provided so as to cover the entire outer surface side of the container body 81. The support part and the like provided to the cover member 85 are not shown in FIG. 13.

A gap (air layer) 87 having a predetermined width is provided between the cover member 85 and the container body 81. In the case that the bread ingredients storage container 80 is configured in this manner, temperature variation inside the bread ingredients storage container 80 can be kept to a minimum by an insulating effect and the possibility of bread ingredients remaining adhered to the interior of the container can be reduced. It is possible to use a configuration in which the air layer 87 is not provided, but the air layer 87 is preferably provided in the manner shown in FIG. 13.

A configuration was described above in which the bread ingredients storage container 80 is provided with a cover member, but it is also possible to use a configuration in which a cover member is not provided. In such a case, the lock mechanism may be directly mounted on the container body 81 and the packing may be secured to the container body 81.

### Second Embodiment

Next, an automatic bread maker according to a second embodiment will be described. The configuration of the automatic bread maker of the second embodiment is substantially similar to the configuration of the automatic bread maker 1 of the first embodiment. Therefore, the same symbols will be used for duplicative portions of the automatic bread maker 1 of the first embodiment, and unless otherwise required, a description thereof will be omitted. The portions that are different from the automatic bread maker 1 of the first embodiment are described below.

The automatic bread maker of the second embodiment is also provided with a bread ingredients storage container 180 mounted on the lid 30. However, the configuration of the bread ingredients storage container 180 is different from the configuration of the bread ingredients storage container 80 of the first embodiment. The second embodiment has a configuration in which the bread ingredients storage container 180 is mounted on the lid 30, but in some cases, it is possible for the bread ingredients storage container to be mounted on the body 10.

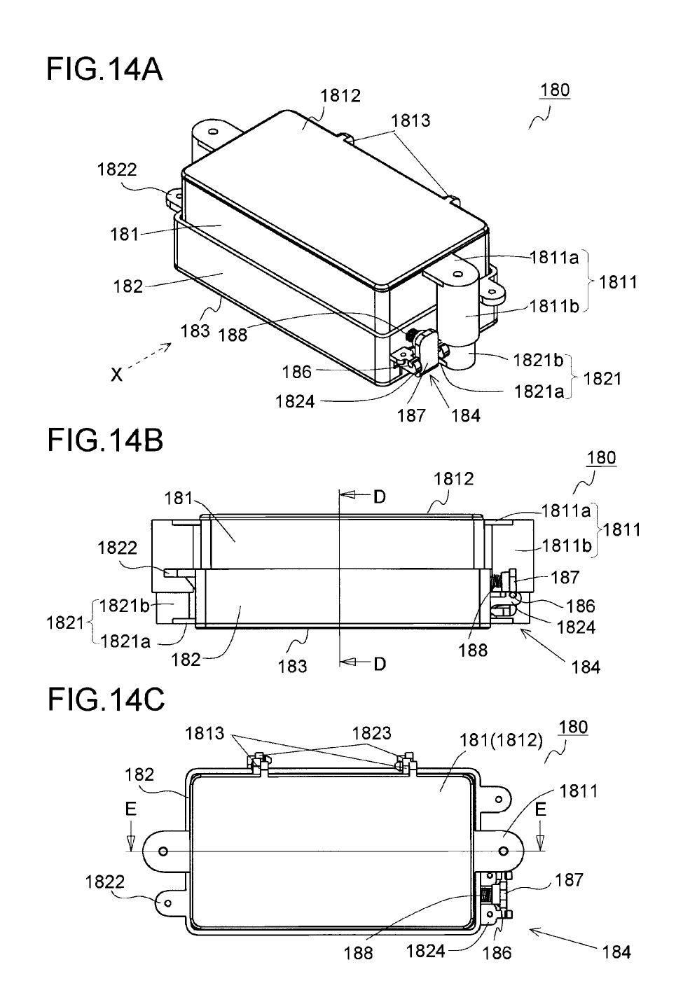

The bread ingredients storage container 180 is a container provided so that a part of the bread ingredients can be automatically fed into the bread container 50 while a bread-making procedure for baking bread is being performed. The configuration of the bread ingredients storage container 180 will be described below with reference to FIGS. 14A, 14B, 14C, 15A, 15B, 15C, 16A, and 16B.

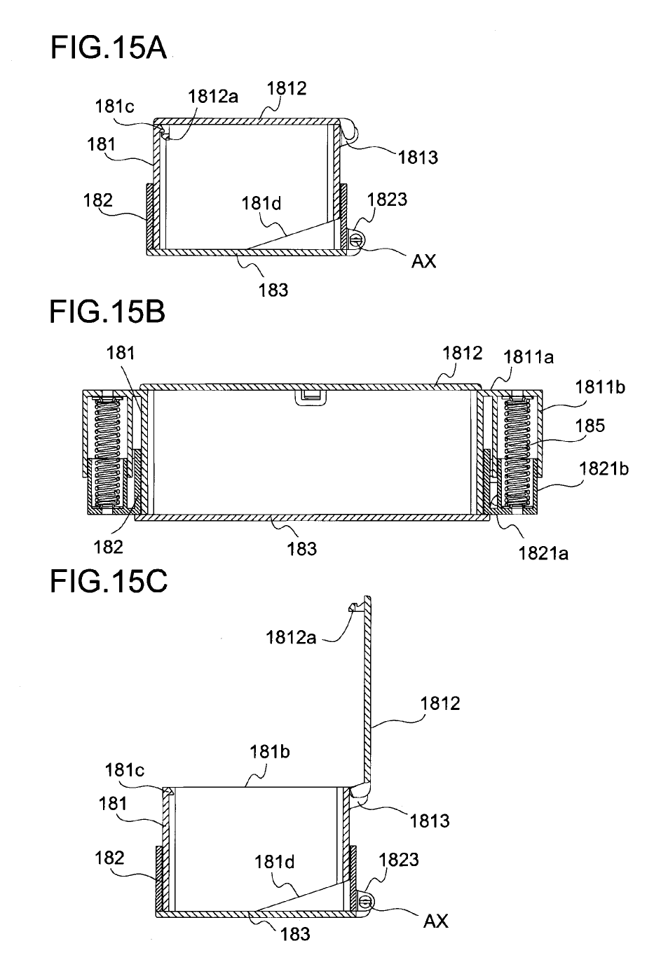

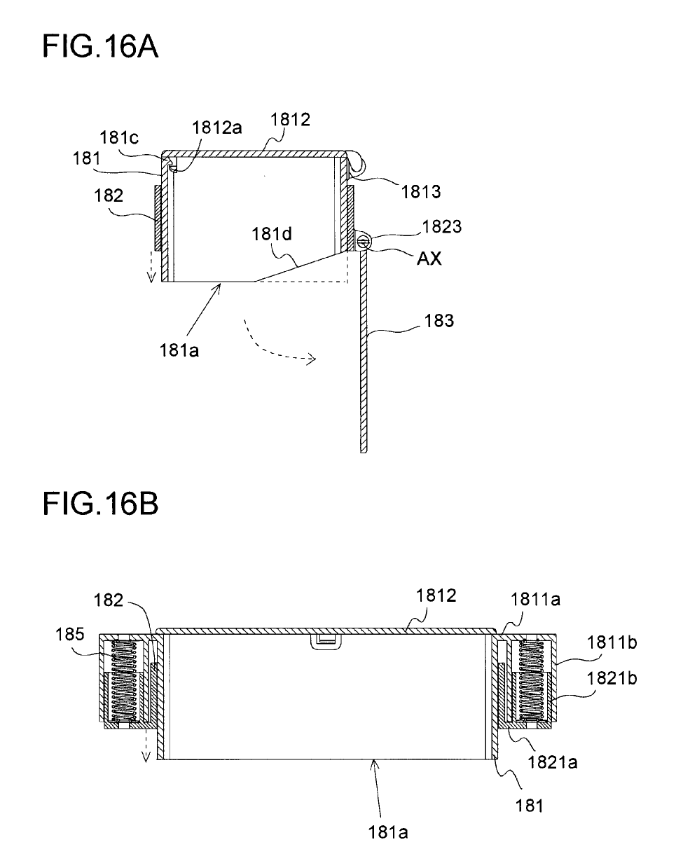

FIG. 14A is a schematic perspective view as seen diagonally from above the bread ingredients storage container provided to the automatic bread maker of the second embodiment. FIG. 14B is a schematic side view of the bread ingredients storage container provided to the automatic bread maker of the second embodiment as seen along the broken line arrow direction X shown in FIG. 14A. FIG. 14C is a schematic plan view as seen from above the bread ingredients storage container provided to the automatic bread maker of the second embodiment. FIGS. 15A, 15B, and 15C are schematic cross-sectional views showing the configuration of the bread ingredients storage container provided to the automatic bread maker of the second embodiment, wherein FIG. 15A is a cross-sectional view at the position D-D of FIG. 14B; FIG. 15B is a cross-sectional view at the position E-E of FIG. 14C; and FIG. 15C is a view showing the state in which the loading port lid part in FIG. 15A is open. FIGS. 16A and 16B are schematic views for illustrating the operation of the bread ingredients storage container provided to the automatic bread maker of the second embodiment, wherein FIG. 16A is a view showing the state in which the lid part in FIG. 15A is open, and FIG. 16B is a view showing the state in which the lid part in FIG. 15B is open.

As shown in FIGS. 14A, 14B, 14C, 15A, 15B, 15C, 16A, and 16B, the bread ingredients storage container 180 is mainly composed of a storage part 181 for storing bread ingredients; a frame part 182 arranged so as to surround the storage part 181 and move in a relative fashion with respect to the storage part 181; a lid part 183 for opening and closing a discharge port 181a provided to the storage part 181; and a lock mechanism 184 for maintaining a state in which the lid part 183 has closed off the discharge port 181a of the storage part 181 (this maintained state corresponds to a locked state in the present invention).

The storage part 181 is a box-shaped member obtained by, e.g., resin molding, the planar shape as viewed from above is substantially rectangular (refer to FIG. 14C), and the side surface shape as viewed from a direction parallel to the lengthwise direction is substantially pentagonal (refer to FIG. 15A). The storage part 181 is arranged in an orientation (e.g., corresponding to the orientation shown in FIGS. 16A and 16B) in which the aperture portion (a substantially rectangular planar shape) of the box that constitutes the discharge port 181a faces the aperture of the bread container 50 (e.g., refer to FIG. 1) in a state in which the lid 30 on which the bread ingredients storage container 180 has been mounted has been closed.

First arm parts 1811 are provided so as to be in a mutually and substantially opposing relationship on the outer surface sides of the sidewalls (of which there are two and which are substantially pentagonal planar shapes) in the crosswise direction of the storage part 181. In other words, a pair of first arm parts 1811 arranged substantially facing each other with the discharge port 181a disposed therebetween is provided to sidewall outer surfaces of the storage part 181. The first arm parts 1811 have a first extending part 1811a that extends from the sidewall upper part side of the storage part 181 in a direction substantially parallel to the lengthwise direction of the storage part 181, and a first cylindrical part 1811b that extends downward in a direction substantially perpendicular to the first extending part 1811a.

In the present embodiment, an ingredient-loading port 181b (refer to FIG. 15C) is provided to the upper surface side (the surface side facing the discharge port 181a) of the storage part 181 so that bread ingredients can be loaded. The ingredient-loading port 181b can be opened and closed by a loading port lid part 1812 swingably supported by a hinge part 1813 provided to a sidewall of the storage part 181. A hook part 1812a is formed on the inner surface side of the loading port lid part 1812, as shown in FIGS. 15A and 15C, and the hook part 1812a engages an engagement part 181c formed on the inner surface side of the sidewall of the storage part 181, whereby the closed state of the loading port lid part 1812 can be maintained. In the present embodiment, the ingredient-loading port 181b (and the loading port lid part 1812 and hinge part 1813 in accompaniment therewith) is provided so that the user can readily store bread ingredients in the bread ingredients storage container 180, but it is also possible to use a configuration in which the ingredient-loading port 181b is not provided. The loading port lid part 1812 and hinge part 1813 in the present embodiment are a part of the storage part of the present invention together with the first arm parts 1811.

The frame part 182 (an embodiment of the colliding part of the present invention) is a frame-shaped member having a substantially rectangular planar shape obtained by, e.g., resin molding, and when viewed from above, the size of the aperture portion is slightly larger than the size of the storage part 181 (refer to FIG. 14C). The frame part 182 is arranged in an orientation in which the aperture plane (substantially rectangular planar shape) is substantially parallel to the aperture plane of the bread container 50 in a state in which the lid 30 on which the bread ingredients storage container 180 has been mounted is closed. The relationship with the storage part 181 described above can be described as a state in which the storage part 181 is fitted into the aperture of the frame part 182. The height (thickness) of the frame part 182 is less than the height of the storage part 181, and the storage part 181 fitted into the aperture of the frame part 182 protrudes from the frame part 182, as shown in FIGS. 14A, 14B, 15A, and 15B.

Second arm parts 1821 are provided so as to be in a mutually and substantially opposing relationship on the outer surface sides of the sidewalls (of which there are two) in the crosswise direction of the frame part 182. In other words, a pair of second arm parts 1821 arranged substantially facing each other with the aperture of the frame part 182 disposed therebetween is provided to sidewall outer surfaces of the frame part 182. The second arm parts 1821 have a second extension part 1821a that extends from the sidewall lower part side of the frame part 182 in a direction substantially parallel to the lengthwise direction of the frame part 182, and a second cylindrical part 1821b that extends upward in a direction substantially perpendicular to the second extension part 1821a. The second cylindrical part 1821b is smaller in size than the first cylindrical part 1811b provided to the storage part 181, and a part of the upper side thereof is fitted into the first cylindrical part 1811b. In contrast to the configuration of the present embodiment, it is also possible to use a configuration in which the first cylindrical part 1811b is smaller in size than the second cylindrical part 1821b and these cylindrical parts are fitted to each other.

An urging spring 185 (an embodiment of the urging member of the present invention) of which one end is secured to the upper part of the first cylindrical part 1811b and the other end is secured to the lower part of the second cylindrical part 1821b is accommodated inside the first cylindrical part 1811b and the second cylindrical part 1821b.

A mounting part 1822 is provided near the upper part of the outer surfaces of the sidewalls (of which there are two; the sidewalls to which the second arm parts 1821 are provided) in the crosswise direction of the frame part 182, and the frame part 182 is thereby securely arranged on the lid 30 (refer to FIG. 1) of the automatic bread maker 1. The storage part 181 fitted into the aperture of the frame part 182 is not secured and is capable of movement (capable of movement in the direction substantially perpendicular to the aperture plane of the frame part 182, i.e., the aperture plane of the bread container 50). Accordingly, the configuration is such that the frame part 182 appears to move in the case that the storage part 181 is used as a reference, and the frame part 182 moves relative to the storage part 181.

The lid part 183 is a substantially rectangular planar member obtained by, e.g., resin molding. The lid part 183 is mounted on the frame part 182 so as to be capable of swinging about a rotating shaft AX (a shaft that extends in the direction substantially perpendicular to the page surface in FIG. 15A), which is substantially parallel to the sidewall (a mutually and substantially orthogonal relationship) in the lengthwise direction and the aperture plane of the frame part 182, by way of a hinge part 1823 (refer to FIGS. 14C and 15A) provided to the outer surface of the lower outer surface side of one of the sidewalls (the sidewall of the back surface side in FIG. 14B) in the lengthwise direction of the frame part 182. The lid part 183 is large enough to completely cover the discharge port 181a of the storage part 181, and is the same size as the frame of the frame part 182 in the present embodiment.

The lock mechanism 184 is configured using a hook support part 1824 provided to the outer surface side of one of the sidewalls in the crosswise direction of the frame part 182; a hook 187 (e.g., resin molded article) supported by the hook support part 1824 so as to be capable of swinging about the shaft 186; and a spring 188 for urging the hook 187 in a direction away from the outer wall to which the hook support part 1824 is provided. The hook 187 urged by the spring 188 catches on an engagement part (not shown) provided to the side surface of the lid part 183, whereby a locked state (the state shown in FIGS. 14A, 14B, 15A, and 15B) is obtained in which the closed state of the discharge port 181a of the storage part 181 is maintained by the lid part 183. In the locked state shown in FIGS. 14A, 14B, 15A, and 15B, the urging springs 185 accommodated inside the first arm parts 1811 and the second arm parts 1812 urge the storage part 181 toward the lid part 183, and the lower surface of the storage part 181 makes contact with the inner surface of the lid part 183 while pressing against the inner surface thereof.

When the hook 187 is pressed against the urging force of the spring 188, the hook 187 swings about the shaft 186. The engagement between the hook 187 and the engagement part provided to the lid part 183 is thereby released and the lid part 183 rotates (refer to FIG. 16A) in the counterclockwise direction about the rotating shaft AX (refer to FIG. 15A). When the lid part 183 rotates, the storage part 181 supported by the lid part 183 in the locked state can no longer obtain support by the lid part 183 and therefore begins to move in the urging direction (downward in the vertical direction) due to the urging force of the urging spring 185. When the storage part 181 has started moving, the distal end (lower end) of the first cylindrical part 1811b (of the first arm parts 1811) provided to the storage part 181 collides with the second extension part 1821a (of the second arm parts 1821) provided to the frame part 182; and storage part 181 stops moving and is supported by the frame part 182 (refer to FIG. 16B).

In the configuration of the present embodiment, the storage part 181 formed in the shape of a box does not have a substantially rectangular parallelepiped shape, but is provided with a sloped surface part 181d, and has a substantially pentagonal shape when viewed from the side surface along the direction parallel to the lengthwise direction. This is due to the fact that the storage part 181 is simultaneously lifted up by the rotation of the lid part 183 in the case that the state has changed from a state in which a part of the storage part 181 protrudes downward from the frame part 182 (the state of FIG. 16A) to a state in which the discharge port 181a of the storage part 181 has been closed by the lid part 183 (the state of FIG. 15A).

In other words, in the case that the storage part 181 is a substantially rectangular parallelepiped shape (the case of the shape shown by the broken line in FIG. 16A), the inner surface side of the lid part 183 comes into contact with the storage part 181 in a state approximate to a state parallel to the vertical direction when the lid part 183 is rotated in the clockwise direction in order to close the discharge port 181a. Therefore, in the case that the storage part 181 is a substantially rectangular parallelepiped shape, the storage part 181 forms an obstruction and the lid part 183 cannot rotate when an attempt is made to cause the lid part 183 to rotate. In view of the above, the user must rotate the lid part 183 after the operation for lifting the storage part 181 has been performed first. In view whereof, the configuration of the present embodiment makes it possible for the inner surface of the lid part 183 to come into contact with the storage part 181 in a state approximate to a state perpendicular to the vertical direction, and the storage part 181 can therefore be simultaneously lifted by the rotation of the lid part 183. Therefore, the configuration of the present embodiment is preferred in that the convenience for the user is improved. However, the storage part 181 may be a substantially rectangular parallelepiped shape without a sloped surface part 181d being provided as in the present embodiment.

The automatic bread maker of the second embodiment can make bread using rice grains (one form of cereal grains), wheat flour, and rice flour as starting ingredients in the same manner as the automatic bread maker 1 of the first embodiment, and the operation thereof is substantially the same as the operation of the automatic bread maker 1 of the first embodiment. The automatic bread maker of the second embodiment features a system in which rice grains are ground and the remaining bread ingredients are automatically fed thereafter in the same manner as the first embodiment. However, since the configuration of the bread ingredients storage container 180 differs from the automatic bread maker 1 of the first embodiment, the automatic bread maker of the second embodiment is different from the automatic bread maker 1 of the first embodiment in terms of operation and the like. The description below is provided by focusing on these differences.

In the case that the user stores, e.g., gluten, yeast, and other bread ingredients in the bread ingredients storage container 180, the lid part 183 provided for opening and closing the discharge port 181a of the storage part 181 is set in a closed state (locked state), as shown in, e.g., FIG. 15C. The bread ingredients to be stored from the ingredient-loading port 181b are stored in the storage part 181 with the loading port lid part 1812 in an open state. The loading port lid part 1812 is closed after the bread ingredients to be stored have been stored. The bread ingredients storage container 180 in which the bread ingredients to be stored have been stored is mounted in a predetermined position on the lid 30 of the automatic bread maker by securing the frame part 182 to the lid 30.

The bread ingredients are automatically fed in the kneading step in the same manner as with the automatic bread maker 1 of the first embodiment in the case that the bread ingredients storage container 180 is used. In the initial stage of the kneading step in which the rotation of the kneading blade 72 is extremely slow, the control apparatus 90 drives the solenoid 19 (an example of the lock release mechanism of the present invention) and releases the locked state of the lock mechanism 184 provided to the bread ingredients storage container 180. The lid part 183 of the bread ingredients storage container 180 thereby rotates to open the discharge port 181a of the storage part 181, and, e.g., the gluten, dry yeast, salt, sugar, shortening, and other such bread ingredients are automatically fed to the bread container 50 (the state shown in FIGS. 16A an 16B).

A preferred configuration is one in which the position of the lid part 183 after the discharge port 181a has opened is a position at which no contact is made with the bread dough in the fermentation step that is performed thereafter. In the present embodiment, the bread ingredients stored in the bread ingredients storage container 180 are fed to the bread container 50 in a state in which the kneading blade 72 is rotating. However, no limitation is imposed thereby, it also being possible for the bread ingredients stored in the bread ingredients storage container 180 to be fed to the bread container 50 in a state in which the kneading blade 72 is stopped. However, in terms of uniformly dispersing the bread ingredients, it is preferred that the bread ingredients be fed in a state in which the kneading blade 72 is rotating in the manner of the present embodiment.

As described above, in the bread ingredients storage container 180, when the operation for opening the discharge port 181a of the storage part 181 is performed (the lid part 183 rotates from the locked state), the storage part 181 begins to move in the urging direction (downward vertical direction) of the urging spring 185 and a collision occurs between the storage part 181 and the frame part 182 (a collision between the first cylindrical part 1811b and the second extension part 1821a). At this time, an impact is imparted (vibrations are generated) to the storage part 181 in which the bread ingredients are stored, and the possibility that bread ingredients will remain in the storage part 181 can therefore be reduced.

As described above, similar to the automatic bread maker 1 of the first embodiment, the automatic bread maker of the second embodiment also makes it possible to bake bread from rice grains, providing great convenience. It is convenient for the user because, e.g., the gluten, dry yeast, and other powdered bread ingredients can be accurately and automatically fed after the rice grains have been ground.

The configuration of the bread ingredients storage container 180 of the second embodiment can be suitably modified. In other words, it is also possible for the sidewalls provided to the first arm parts 1811 and the second arm parts 1821 to be sidewalls in the lengthwise direction rather than sidewalls in the crosswise direction, and the number of arm parts may be suitably modified. It is also possible to suitably modify the rotational direction of the lid part when the lid part 183 is opened, the position in which the lock mechanism 184 is provided, and other parameters. Further, the location in which the storage part 181 and the frame part 182 collide in the case that the storage part 181 has moved is not limited to the configuration of the present embodiment and may be suitably modified. Other configurations are also possible as long as shock is imparted to the storage part 181 by collision between the two.

In the bread ingredients storage container 180 of the second embodiment, a configuration is used in which the frame part 182 is in a secured arrangement and the storage part 181 is capable of movement to thereby obtain a frame part that moves in a relative fashion with respect to the storage part in the present invention. However, no limitation is imposed by this configuration, and it is also possible to use a configuration in which the storage part 181 is, e.g., arranged so as to be secured to the lid 30 of the automatic bread maker, and the frame part 82 is capable of movement (i.e., movement relative to the storage part 181). In this case as well, a configuration is obtained in which the storage part 181 and the frame part 182 collide, and the possibility that bread ingredients will remain inside the bread ingredients storage container 180 can be reduced.

In the bread ingredients storage container 180 of the second embodiment, the colliding part of the present invention is configured using a frame part 182, but it is also possible to use a configuration in which the colliding part is different from the frame part 182. In short, other configurations are also possible as long as there is a collision with the storage part 181 in the case that the locked state by the lock mechanism 184 is released and the discharge port 181a of the storage part 181 is opened. Such configurations may also include a solenoid or the like.

### Other Embodiments

The automatic bread maker illustrated above is an example of the present invention, but the configuration of an automatic bread maker in which the present invention is applied is not limited by the embodiments illustrated above.

The embodiments described above are configured so that bread is made from rice grains, but the present invention is not limited to rice grains and can also be applied to cases in which bread is made from wheat, barley, millet, Japanese millet, buckwheat, corn, soy beans, and other cereal grains as ingredients.

The bread-making steps performed in the above-described bread-making procedure for rice grains are given by way of example, and other steps may be employed. For example, the immersion step may be performed again after which the kneading step is performed in order to cause the ground flour to absorb the water after the grinding step when bread is to be made from rice grains.

The embodiment described above is configured such that the automatic bread maker comprises two blades, i.e., the grinding blade 54 and the kneading blade 72, with separate motors fitted respectively thereto. However, no limitation is imposed thereby, it also being possible to use a configuration in which, e.g., a blade and motor are used both for grinding and kneading. A configuration may also be adopted in which the bread-making procedure performed in the automatic bread maker is only a procedure for making bread from rice grains.

### INDUSTRIAL APPLICABILITY

The present invention is suitably used in an automatic bread maker for household use.

### LIST OF REFERENCE SIGNS

1 automatic bread maker
10 body
19 solenoid (lock release mechanism)
50 bread container
54 grinding blade (a part of the grinding mechanism)
60 kneading motor (a part of the kneading mechanism)
64 grinding motor (a part of the grinding mechanism)
72 kneading blade (a part of the kneading mechanism)
80, 180 bread ingredients storage containers
81 container body
81a aperture
82 lid body
83 coating layer
84 packing (seal member)
85 cover member
85b clamp hook support part (a part of the lock mechanism)
86 clamp hook (lock member, a part of the lock mechanism)
87 air layer
852 shaft (a part of the lock mechanism)
853 spring (a part of the lock mechanism)
181 storage part
181a discharge port
181b ingredient-loading port
181d sloped surface
182 frame part (colliding part)
183 lid part
184 lock mechanism
185 urging spring (urging member)
186 shaft (a part of the lock mechanism)
187 hook (a part of the lock mechanism)
188 spring (a part of the lock mechanism)
1811 first arm part
1811a first extension part (a part of the first arm part)
1811b first cylindrical part (a part of the first arm part)
1821 second arm part
1821a second extension part (a part of the second arm part)
1821b second cylindrical part (a part of the second arm part)
1824 hook support part (a part of the lock mechanism)

1. An automatic bread maker comprising:
a body in which a bread container is accommodated;
a grinding mechanism for grinding cereal grains in the container accommodated in the body;
a kneading mechanism for kneading into dough bread ingredients in the bread container accommodated in the body; and
a bread ingredients storage container for storing powdered bread ingredients to be automatically fed into the bread container after the cereal grains have been ground by the grinding mechanism.

2. The automatic bread maker of claim 1, wherein
bread-making steps performed when bread is to be made from cereal grains include a grinding step for mixing the cereal grains with a liquid, and grinding the cereal grains using the grinding mechanism; and a kneading step for kneading into a dough the bread ingredients including ground flour obtained by the grinding step using the kneading mechanism.

3. The automatic bread maker of claim 1, wherein
the bread ingredients storage container has:
a container body having an aperture part;
a lid body capable of opening and closing the aperture part, the lid body being swingably provided with respect to the container body;
a seal member for sealing the space between the container body and the lid body in a state in which the aperture part has been closed by the lid body; and
a lock mechanism for supporting the lid body from the outer surface side and maintaining the state in which the aperture part is closed.

4. The automatic bread maker of claim 3, wherein the seal member is secured to the container body so as to not protrude into the aperture part.

5. The automatic bread maker of claim 3, wherein an inner surface of the container body and the lid body is a smooth surface formed without concavities and convexities.

6. The automatic bread maker of claim 3, wherein the container body and the lid body are made of metal.

7. The automatic bread maker of claim 6, wherein a coating layer is formed on an inner surface of the container body and the lid body.

8. The automatic bread maker of claim 3, wherein
the bread ingredients storage container further has a cover member for securing the seal member to the container body;
the lock mechanism is provided to the cover member; and
the lid body is swingably mounted on the cover member.

9. The automatic bread maker of claim 8, wherein the cover member is provided so as to cover the container body.

10. The automatic bread maker of claim 9, wherein an air layer is formed between the cover member and the container body.

11. The automatic bread maker of claim 3,
further comprising a lock release mechanism for releasing a locked state produced by the lock mechanism, wherein
the bread ingredients storage container is arranged so that the aperture part faces the aperture of the bread container; and
by releasing the lock produced by the lock-release mechanism the lid body swings, the aperture part opens, and the bread ingredients stored in the bread ingredients storage container are fed into the bread container.

12. The automatic bread maker of claim 11, wherein
the lock mechanism includes a lock member for supporting the lid body from the outer surface side and maintaining the state in which the aperture part is closed; and
the lock release mechanism presses the lock member and releases the locked state.

13. The automatic bread maker of claim 12, wherein the lock release mechanism is intermittently driven in order to apply shock to the lock member after the locked state has been released.

14. The automatic bread maker of claim 1, wherein
the bread ingredients storage container has:
a storage part for storing the bread ingredients, the storage part being provided with a discharge port for discharging the bread ingredients into the bread container;
a lid part for opening and closing the discharge port;
a lock mechanism for maintaining a state in which the discharge port is closed by the lid part;
a lock release mechanism for releasing the locked state produced by the lock mechanism; and
a colliding part that collides with the storage part in a case where the locked state is released by the lock release mechanism and the discharge port is opened.

15. The automatic bread maker of claim 14, wherein
the colliding part is a frame part arranged so as to surround the storage part, the colliding part moving relative to the storage part; and
a collision occurs between the storage part and the frame part by the relative movement in the case that the locked state has been released by the lock release mechanism and the discharge port has been opened.

16. The automatic bread maker of claim 15, wherein
in a state in which the bread ingredients are fed from the bread ingredients storage container to the bread container, the frame part is securely arranged so that the aperture plane thereof is substantially parallel to the aperture plane of the bread container, and the storage part is arranged so that the discharge port faces the aperture of the bread container, the storage part being provided so as to be capable of movement in a direction substantially perpendicular to the aperture plane of the bread container;
the lid part is swingably mounted on the frame part;
a pair of first arm parts arranged substantially facing each other with the discharge port disposed therebetween is provided to a sidewall outer surface of the storage part, the first arm parts having a first cylindrical part that extends in a direction substantially parallel to the direction in which the storage part is capable of moving;
a pair of second arm parts is provided to a sidewall outer surface of the frame part, the second arm parts being arranged substantially facing each other with an aperture of the sidewall outer surface disposed therebetween, and having a second cylindrical part that fits with the first cylindrical part and extends in a direction substantially parallel to the first cylindrical part;
an urging member for urging the storage part toward the lid part is accommodated inside the first cylindrical part and the second cylindrical part in a state in which the discharge port has been closed by the lid part; and
releasing of the locked state and the lid part rotating causes the storage part to move in the urging direction of the urging member, and the first arm parts and the second arm parts to collide.

17. The automatic bread maker of claim 16, wherein a sloped surface part is formed on the storage part so that the storage part can be pressed by the lid part and moved in a direction opposite the urging direction as a consequence of the lid part being caused to rotate in the case that the locked state has been released, the storage part has moved in the urging direction, and a part of the storage part is in a state of protruding from the frame part in the urging direction.

18. The automatic bread maker of claim 14, wherein an ingredient-loading port that can be opened and closed in order for bread ingredients to be loaded is provided to the storage part separately from the discharge port.
